(19) United States
(12) Patent Application Publication
(10) Pub. No.: US 2025/0346090 A1
(43) Pub. Date: Nov. 13, 2025

(54) ELECTRIC VEHICLE BATTERY THERMAL MANAGEMENT SYSTEM

(71) Applicant: KING FAHD UNIVERSITY OF PETROLEUM AND MINERALS, Dhahran (SA)

(72) Inventors: Yousif M. ALKHULAIFI, Dhahran (SA); Naef A.A. QASEM, Dhahran (SA); Syed Mohammad ZUBAIR, Dhahran (SA)

(73) Assignee: KING FAHD UNIVERSITY OF PETROLEUM AND MINERALS, Dhahran (SA)

(21) Appl. No.: 19/277,493

(22) Filed: Jul. 23, 2025

Related U.S. Application Data
(62) Division of application No. 17/899,181, filed on Aug. 30, 2022.

(51) Int. Cl. B60H 1/00; B60L 58/26; H01M 10/613; H01M 10/625

(52) U.S. Cl. CPC B60H 1/00278; B60H 1/004; B60H 1/00885; B60L 58/26; H01M 10/613; H01M 10/625; B60H 2001/00307

(57) ABSTRACT

A battery thermal management system (BTMS) for an electric vehicle and a hybrid electric vehicle is provided. The BTMS includes a refrigerant circuit having an evaporator, a chiller, one or more condensers, a compressor, an ejector, a primary directional control valve (DCV), a secondary DCV, an ejector DCV, a compressor input and output DCVs, a reference DCV, throttling valves, and controller to cool or heat the battery and passenger cabin. A coolant circuit having the battery, battery cooler, a battery output DCV, and a battery input DCV is communicated with the refrigerant circuit via the chiller. The battery input and output DCVs are coupled to the battery cooler and coupled to each other to isolate the refrigerant circuit. The controller controls the DCVs based on an optimal battery temperature range, coolant temperature, ambient temperature, passenger cabin temperature, and optimal passenger cabin temperature range.

### BACKGROUND

### Technical Field

The present disclosure is directed to a thermal management system for a battery of electric and hybrid electric vehicles, and, more particularly, relates to an ejector-based thermal management system for controlling a temperature of a battery of the electric and hybrid electric vehicles during a cooling mode and a heating mode.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Environmental protection and pollution mitigation efforts are critical to alleviate climate change's consequences. Transportation sector is a major contributor for the pollution with an estimate of 23% of global CO₂ emissions. Consequently, electric vehicles (EVs) and hybrid electric vehicles (HEVs) are developed as suitable replacements for the vehicles run by internal combustion (IC) engine. HEVs incorporate an IC engine and a battery to operate whereas EVs are operated by a battery, and, therefore, a temperature of the battery should be controlled for efficient operation thereof. Further, fast charging technologies need to be developed to enable recharging of the batteries as fast as refuelling an IC engine vehicle. Since high-speed charging causes significant heat generation, controlling temperature rise within cells of the battery and across battery modules is critical for the efficient operation of the battery. Therefore, there is a need remains to develop a battery thermal management system (BTMS) that can have a capacity of 15-25 kW to meet the high-speed charging requirements.

U.S. Pat. No. 8,215,432B2 describes a battery thermal system having a refrigerant-to-coolant heat exchanger, a battery radiator, a cooling fan, a valve, and an electric pump. The refrigerant-to-coolant heat exchanger selectively receives a refrigerant from vehicle air conditioning system. The valve receives a liquid coolant from a battery pack and selectively redirects the liquid coolant to the refrigerant-to-coolant heat exchanger and the battery radiator. The battery thermal system also includes a battery coolant heater for selectively heating the coolant that flows into the battery pack. However, the system lacks energy boosting elements to reduce power consumption of refrigeration cycle and does no include bypass lines between the refrigerant and coolant circuits.

WO2019150034A1 describes a refrigerant circuit having a compression device, a refrigerant ejector, a first thermal exchanger, a second thermal exchanger, a heat exchanger, and an accumulation device. The refrigerant circuit includes the heat exchanger which is thermally coupled to an electrical storage device of the vehicle. The accumulation device includes a first branch carrying the heat exchanger and a second branch connected to the ejector. However, the ejector acts as a mixing device rather than an energy efficiency device. Further, the system does not describe a method for rejecting heat generated in the electrical storage device when small amount of heat rejection is needed.

JP 05637165 B2 describes separate systems such as: (i) a heating, ventilating, and air-conditioning system (HVAC) for a passenger cabin using a refrigerant-based system, (ii) a battery coolant circulation system, and (iii) a dedicated refrigerant-based cooling system for the battery. The battery coolant system and the refrigerant-based cooling system constitute the battery heating/cooling system. The HVAC system describes a conventional vapor-compression refrigeration system composed of a compressor, condenser, throttling valve, and an evaporator. However, the separate systems add complexity and does not include energy boosting elements to improve operational performance of the system.

CN102315498B describes a refrigerant loop including a compressor, a condenser, an evaporator, a chiller, and throttling valves, and a coolant loop including a pump and a battery. The heat generated by the battery in this system is rejected to the chiller in such a case the compressor is always operated to cool the battery, which makes the system less energy efficient.

CN110411051A describes a thermal management system including a compressor, a high-pressure cooler, an evaporator cell cooler, a gas-liquid separator, and an ejector. Primary inlet and secondary inlet of the ejector are connected to the high-pressure cooler and the evaporator, respectively, and thus the ejector acts only as a mixing device and does not help in improving energy efficiency of the system. Further, the gas-liquid separator makes the system complex, and the system does not mention cooling operation of the battery.

Each of the aforementioned references suffers from one or more drawbacks hindering their adoption. Accordingly, it is one object of the present disclosure to provide methods and systems for controlling the temperature of the battery based on a dual-evaporator vapor compression system equipped with an ejector, which helps to boost inlet pressure of the compressor without increasing complexity of the system. As the ejector is a simple component with no moving parts, installation, testing, and operation of the system are simplified.

### SUMMARY

In an exemplary embodiment, a battery thermal management system (BTMS) for an electric vehicle (EV) in a cooling mode or a heating mode is disclosed. The EV includes a battery, a first condenser for heating a passenger cabin of the EV, a second condenser for heating the battery, a third condenser, a compressor, a chiller for cooling the battery, a first evaporator for cooling the passenger cabin, and a second evaporator. The BTMS includes an ejector, a primary directional control valve (DCV), a secondary DCV, an ejector DCV, a compressor input DCV, a compressor output DCV, a reference DCV, a battery output DCV, a battery input DCV and a controller. The ejector has a primary inlet, a secondary inlet and an output. The primary DCV is configured to couple the first evaporator to the primary inlet of the ejector or to the secondary DCV in the cooling mode, and to couple the first condenser to the primary inlet of the ejector or to the secondary DCV in the heating mode. The secondary DCV is configured to couple the primary DCV and the chiller to the secondary inlet of the ejector or to the ejector DCV in the cooling mode, and to couple the primary DCV and the second condenser to the secondary inlet of the ejector or to the ejector DCV in the heating mode. The ejector DCV is configured to couple the output of the ejector or the secondary DCV to the compressor input DCV in the cooling mode or to the second evaporator in the heating mode. The compressor input DCV is configured to couple the ejector DCV to the compressor in the cooling mode, or to couple the reference DCV to the compressor in the heating mode. The compressor output DCV is configured to couple the compressor to the third condenser in the cooling mode or to at least one of the first condenser and the second condenser in the heating mode. The reference DCV is configured to couple the third condenser to at least one of the first evaporator and the chiller in the cooling mode or to couple the second evaporator to the compressor input DCV in the heating mode. The battery output DCV is configured to couple the battery to the chiller or to the battery input DCV in the cooling mode, or to couple the battery to the second condenser or to the battery input DCV in the heating mode. The battery input DCV is configured to couple the battery output DCV or the chiller to the battery in the cooling mode, or to couple the second condenser or the battery output DCV to the battery in the heating mode. The controller is configured to control the primary DCV, the secondary DCV, the ejector DCV, the compressor input DCV, the compressor output DCV, the reference DCV, the battery input DCV and the battery output DCV based on an optimal battery temperature range of the battery, a coolant temperature of the battery, an ambient temperature of the EV, a passenger cabin temperature of the passenger cabin, and/or an optimal passenger cabin temperature range of the passenger cabin.

In some embodiments, the EV further includes a battery cooler. The battery output DCV is further configured to couple the battery to the battery cooler, and the battery input DCV is further configured to couple the battery cooler to the battery.

In some embodiments, when the coolant temperature is higher than the optimal battery temperature range and the ambient temperature is lower than the optimal battery temperature range, the controller controls the battery output DCV to couple the battery to the battery cooler and controls the battery input DCV to couple the battery cooler to the battery.

In some embodiments, when the coolant temperature is higher than the optimal battery temperature range and the ambient temperature is higher than the coolant temperature, the controller controls the battery output DCV to couple the battery to the chiller and controls the battery input DCV to couple the chiller to the battery.

In some embodiments, when the coolant temperature is within the optimal battery temperature range, the controller controls the battery output DCV to couple the battery to the battery input DCV and controls the battery input DCV to couple the battery output DCV to the battery.

In some embodiments, the BTMS includes a throttling valve coupled between the first evaporator and the reference DCV. When the coolant temperature is higher than the optimal battery temperature range and the passenger cabin temperature is within the optimal passenger cabin temperature range, the controller controls the throttling valve to be closed, controls the primary DCV to couple the first evaporator to the secondary DCV, and controls the secondary DCV to couple the primary DCV and the chiller to the ejector DCV.

In some embodiments, when the coolant temperature is lower than the optimal battery temperature range and the ambient temperature is lower than the coolant temperature, the controller controls the battery output DCV to couple the battery to the second condenser and controls the battery input DCV to couple the second condenser to the battery.

In some embodiments, the BTMS further includes a throttling valve coupled between the first condenser and the reference DCV. When the coolant temperature is lower than the optimal battery temperature range and the passenger cabin temperature is within the optimal passenger cabin temperature range, the controller controls the throttling valve to be closed, controls the primary DCV to couple the first condenser to the secondary DCV, and controls the secondary DCV to couple the primary DCV and the second condenser to the ejector DCV.

In some embodiments, the EV is a hybrid electric vehicle (HEV), and the controller is configured to control the primary DCV, the secondary DCV, the ejector DCV, the compressor input DCV, the compressor output DCV, the reference DCV, the battery input DCV and the battery output DCV further based on an engine operation of the HEV.

In another exemplary embodiment, a battery thermal management system (BTMS) for an electric vehicle (EV) in a cooling mode or a heating mode is disclosed. The EV includes a battery, a first condenser for heating a passenger cabin of the EV, a second condenser for heating the battery, a third condenser, a compressor, a chiller for cooling the battery, a first evaporator for cooling the passenger cabin, and a second evaporator. The BTMS includes an ejector, a primary directional control valve (DCV), a secondary DCV, an ejector DCV, a reversing valve, a battery output DCV, a battery input DCV and a controller. The ejector has a primary inlet, a secondary inlet and an output. The primary DCV is configured to couple the first evaporator to the primary inlet of the ejector or to the secondary DCV in the cooling mode, and to couple the secondary DCV to the first condenser in the heating mode. The secondary DCV is configured to couple the primary DCV and the chiller to the secondary inlet of the ejector or to the ejector DCV in the cooling mode, and to couple the ejector DCV to the primary DCV and the second condenser in the heating mode. The ejector DCV is configured to couple the output of the ejector or the secondary DCV to the reversing valve in the cooling mode, or to couple the reversing valve to secondary DCV in the heating mode. The reversing valve is configured to couple the ejector DCV through the compressor to the third condenser in the cooling mode, or to couple the second evaporator through the compressor to the ejector DCV in the heating mode. The battery output DCV is configured to couple the battery to the chiller or to the battery input DCV in the cooling mode, or to couple the battery to the second condenser or to the battery input DCV in the heating mode. The battery input DCV is configured to couple the battery output DCV or the chiller to the battery in the cooling mode, or to couple the second condenser or the battery output DCV to the battery in the heating mode. The controller is configured to control the primary DCV, the secondary DCV, the ejector DCV, the reversing valve, the battery input DCV and the battery output DCV based on an optimal battery temperature range of the battery, a coolant temperature of the battery, an ambient temperature of the EV, a passenger cabin temperature of the passenger cabin, and/or an optimal passenger cabin temperature range of the passenger cabin.

In some embodiments, the EV further includes a battery cooler. The battery output DCV is further configured to couple the battery to the battery cooler, and the battery input DCV is further configured to couple the battery cooler to the battery.

In some embodiments, when the coolant temperature is higher than the optimal battery temperature range and the ambient temperature is lower than the optimal battery temperature range, the controller controls the battery output DCV to couple the battery to the battery cooler and controls the battery input DCV to couple the battery cooler to the battery.

In some embodiments, when the coolant temperature is higher than the optimal battery temperature range and the ambient temperature is higher than the coolant temperature, the controller controls the battery output DCV to couple the battery to the chiller and controls the battery input DCV to couple the chiller to the battery.

In some embodiments, when the coolant temperature is within the optimal battery temperature range, the controller controls the battery output DCV to couple the battery to the battery input DCV and controls the battery input DCV to couple the battery output DCV to the battery.

In some embodiments, the BTMS further includes a throttling valve coupled between the first evaporator and the third condenser. When the coolant temperature is higher than the optimal battery temperature range and the passenger cabin temperature is within the optimal passenger cabin temperature range, the controller controls the throttling valve to be closed, controls the primary DCV to couple the first evaporator to the secondary DCV, and controls the secondary DCV to couple the primary DCV and the chiller to the ejector DCV.

In some embodiments, when the coolant temperature is lower than the optimal battery temperature range and the ambient temperature is lower than the coolant temperature, the controller controls the battery output DCV to couple the battery to the second condenser and controls the battery input DCV to couple the second condenser to the battery.

In some embodiments, the BTMS further includes a throttling valve coupled between the first condenser and the second evaporator. When the coolant temperature is lower than the optimal battery temperature range and the passenger cabin temperature is within the optimal passenger cabin temperature range, the controller controls the throttling valve to be closed, controls the primary DCV to couple the first condenser to the secondary DCV, and controls the secondary DCV to couple the primary DCV and the second condenser to the ejector DCV.

In some embodiments, the EV is a hybrid electric vehicle (HEV), and the controller is configured to control the primary DCV, the secondary DCV, the ejector DCV, the reversing valve, the battery input DCV and the battery output DCV further based on an engine operation of the HEV.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic block diagram of a battery thermal management system (BTMS) for an electric vehicle (EV), according to certain embodiments of the present disclosure.

FIG. 2 shows a temperature-entropy diagram of the BTMS in a cooling mode thereof, according to certain embodiments of the present disclosure.

FIG. 3 is an exemplary illustration of an ejector of the BTMS, according to certain embodiments of the present disclosure.

FIG. 4 is a schematic block diagram of the BTMS operating in the cooling mode while a first evaporator and a chiller are activated and the ejector is isolated, according to certain embodiments of the present disclosure.

FIG. 5 is a schematic block diagram of the BTMS operating in the cooling mode while the chiller is activated and the ejector and the first evaporator are isolated, according to certain embodiments of the present disclosure.

FIG. 6 is a schematic block diagram of the BTMS operating in the cooling mode while the first evaporator is activated and the ejector and the chiller are isolated, according to certain embodiments of the present disclosure.

FIG. 7 is a schematic block diagram of the BTMS operating in a heating mode while a first condenser and a second condenser are activated, according to certain embodiments of the present disclosure.

FIG. 8 shows a temperature-entropy diagram of the BTMS in the heating mode thereof, according to certain embodiments of the present disclosure.

FIG. 9 is a schematic block diagram of the BTMS operating in the heating mode while the second condenser is activated and the first condenser is isolated, according to certain embodiments of the present disclosure.

FIG. 10 is a schematic block diagram of the BTMS operating in the heating mode while the first condenser is activated and the second condenser is isolated, according to certain embodiments of the present disclosure.

FIG. 11 is an exemplary flowchart of a method of operating the BTMS implemented in the EV, according to certain embodiments of the present disclosure.

FIG. 12 is a schematic block diagram of a BTMS for a hybrid electric vehicle (HEV) operating in a cooling mode while the first evaporator and the chiller are activated, according to certain embodiments of the present disclosure.

FIG. 13 is a schematic block diagram of the BTMS of FIG. 12 operating in the cooling mode while the ejector is isolated, according to certain embodiments of the present disclosure.

FIG. 14 is a schematic block diagram of the BTMS of FIG. 12 operating in the cooling mode while the chiller is activated and the ejector and the first evaporator are isolated, according to certain embodiments of the present disclosure.

FIG. 15 is a schematic block diagram of the BTMS of FIG. 12 operating in the cooling mode while the first evaporator is activated and the ejector and the chiller are isolated, according to certain embodiments of the present disclosure.

FIG. 16 is a schematic block diagram of the BTMS of FIG. 12 operating in a heating mode while the first condenser and the second condenser are activated, according to certain embodiments of the present disclosure.

FIG. 17 is a schematic block diagram of the BTMS of FIG. 12 operating in the heating mode while the second condenser is activated and the first condenser is isolated, according to certain embodiments of the present disclosure.

FIG. 18 is a schematic block diagram of the BTMS of FIG. 12 operating in the heating mode while the first condenser is activated and the second condenser is isolated, according to certain embodiments of the present disclosure.

FIG. 19 is a schematic block diagram of the BTMS of FIG. 12 operating in the heating mode while a coolant circuit is activated to use heat of an engine to heat a coolant of a battery and a refrigerant circuit is isolated, according to certain embodiments of the present disclosure.

FIG. 20 is an exemplary flowchart of a method of operating the BTMS implemented in the HEV, according to certain embodiments of the present disclosure.

FIG. 21 is a schematic block diagram of a BTMS having a reversing valve implemented in the EV and operating in a cooling mode while the first evaporator and the chiller are activated, according to certain embodiments of the present disclosure.

FIG. 22 is a schematic block diagram of the BTMS of FIG. 21 operating in the cooling mode while the ejector is isolated, according to certain embodiments of the present disclosure.

FIG. 23 is a schematic block diagram of the BTMS of FIG. 21 operating in the cooling mode while the chiller is activated and the ejector and the first evaporator are isolated, according to certain embodiments of the present disclosure.

FIG. 24 is a schematic block diagram of the BTMS of FIG. 21 operating in the cooling mode while the first evaporator is activated and the ejector and the chiller are isolated, according to certain embodiments of the present disclosure.

FIG. 25 is a schematic block diagram of the BTMS of FIG. 21 operating in a heating mode while the first condenser and the second condenser are activated, according to certain embodiments of the present disclosure.

FIG. 26 is a schematic block diagram of the BTMS of FIG. 21 operating in the heating mode while the second condenser is activated and the first condenser is isolated, according to certain embodiments of the present disclosure.

FIG. 27 is a schematic block diagram of the BTMS of FIG. 21 operating in the heating mode while the first condenser is activated and the second condenser is isolated, according to certain embodiments of the present disclosure.

FIG. 28 is a schematic block diagram of a BTMS implemented in the HEV and operating in a heating mode while a coolant circuit is activated to use heat of the engine to heat the coolant of the battery and a refrigerant circuit is isolated, according to certain embodiments of the present disclosure.

FIG. 29 is a schematic chart illustrating a summary of operating modes of the refrigerant circuit of the BTMS implemented in the EV and the HEV, according to certain embodiments of the present disclosure.

FIG. 30 is a schematic tabular representation illustrating gate selection of each of a plurality of directional control valves, a plurality of throttling valves and an on/off valve employed in the BTMS of FIG. 1 and FIG. 12, according to certain embodiments of the present disclosure.

FIG. 31 is a schematic tabular representation illustrating gate selection of each of a plurality of directional control valves and a plurality of throttling valves employed in the BTMS of FIG. 21, according to certain embodiments of the present disclosure.

FIG. 32 is a schematic chart illustrating a summary of operating modes of the coolant circuit of the BTMS implemented in the EV and the HEV, according to certain embodiments.

FIG. 33 is an illustration of a non-limiting example of details of computing hardware used in a controller of the BTMS, according to certain embodiments of the present disclosure.

FIG. 34A is a graphical representation showing an influence of temperature values of the first evaporator and the chiller on coefficient of performance (COP) of an ejector-based BTMS compared to a reference system, according to certain embodiments of the present disclosure.

FIG. 34B is a graphical representation showing improvements in the COP of the ejector-based BTMS compared to the reference system, according to certain embodiments of the present disclosure.

FIG. 35 is a graphical representation showing an effect of evaporator temperature on compression power of the ejector-based BTMS at various operating scenarios, according to certain embodiments of the present disclosure.

FIG. 36 is a three dimensional (3D) surface plot showing total cost rate for different evaporator and condenser temperature values of the ejector-based BTMS, according to certain embodiments of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a battery thermal management system (BTMS) implemented in an electric vehicle (EV) and a hybrid electric vehicle (HEV) and methods for controlling a heating mode and a cooling mode of the BTMS based on an operating temperature of a battery used for driving the EV and the HEV. The BTMS includes a refrigerant circuit based on a dual vapor compression refrigeration system having an evaporator and a chiller, and a coolant circuit linked via the chiller to cool a coolant of the battery in the cooling mode. The evaporator is used for cooling a passenger cabin of the EV and the HEV. In the heating mode, the evaporator and the chiller act as condensers for heating the passenger cabin and the coolant of the battery. Further, an ejector is employed in the BTMS to increase an inlet pressure of a compressor of the refrigerant circuit. In an embodiment, some of the compression burdens are shifted away from the compressor to the ejector by leveraging different refrigerant pressures from the chiller and the evaporator.

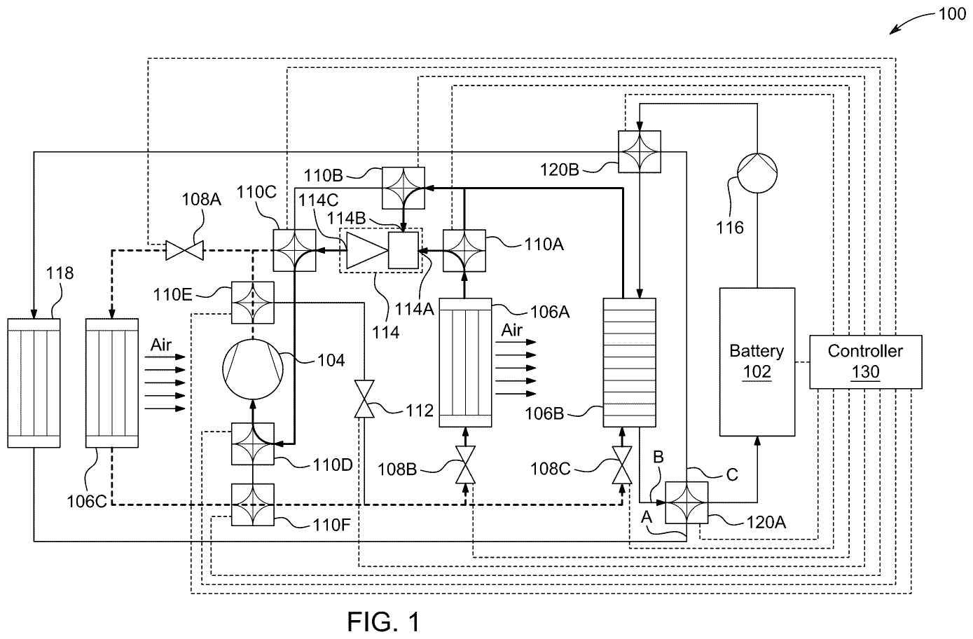

Referring to FIG. 1, a schematic block diagram of a battery thermal management system (BTMS) 100 for an electric vehicle (EV) is illustrated, according to an embodiment of the present disclosure. In an embodiment, the BTMS 100 is configured to control an operating temperature of a battery 102 of the EV during a heating mode and a cooling mode thereof. The battery 102 is a primary source of power for driving the EV efficiently at a desired operating condition of the EV. The EV includes a compressor 104, a plurality of heat exchangers, and a plurality of throttling valves for heating or cooling the battery 102 and a passenger cabin of the EV. The compressor 104 is configured to increase a temperature and a pressure of a working gas, such as a refrigerant in a refrigeration system. In the refrigeration system, the refrigerant enters the compressor 104 at a low pressure and a low temperature and leaves the compressor 104 at a high temperature and a high pressure. The plurality of heat exchangers includes a first heat exchanger 106A, which is alternatively referred to as the first evaporator 106A and the first condenser 106A during the cooling mode and the heating mode, respectively, of the BTMS 100, a second heat exchanger 106B, which is alternatively referred to as the chiller 106B and the second condenser 106B during the cooling mode and the heating mode, respectively, of the BTMS 100, and a third heat exchanger 106C, which is alternatively referred to as the third condenser 106C and the second evaporator 106C during the cooling mode and the heating mode, respectively, of the BTMS 100.

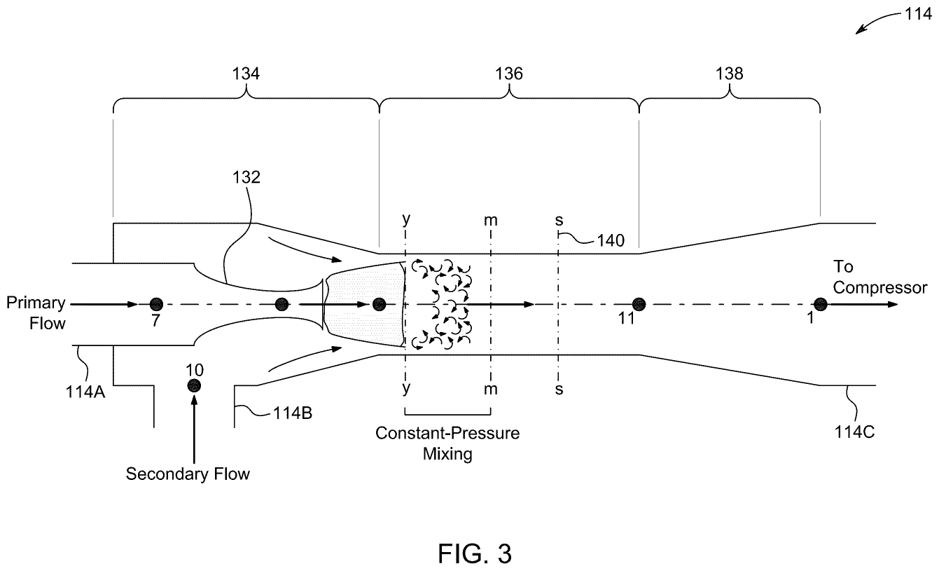

According to the present disclosure, the BTMS 100 includes a refrigerant circuit and a coolant circuit. The refrigerant circuit includes a vapor compression refrigeration system having the first heat exchanger 106A, the second heat exchanger 106B, the third heat exchanger 106C, the compressor 104, the plurality of throttling valves, a first set of directional control valves (DCVs) and an on/off valve 112. During an operation of the BTMS 100, the first set of DCVs may be controlled to direct a flow of the refrigerant though the refrigerant circuit to cool or heat the passenger cabin of the EV and the battery 102 as per the desired operating condition of the EV. The refrigerant circuit further includes an ejector 114 having a primary inlet 114A configured to communicate with the first heat exchanger 106A, a secondary inlet 114B configured to communicate with the first and second heat exchangers 106A, 106B, and an output 114C configured to communicate with the third heat exchanger 106C and the compressor 104 based on the desired operating condition of the EV and operating modes of the BTMS 100. The ejector 114 is configured to mix refrigerant streams coming from the first heat exchanger 106A and the second heat changer 106B to reduce power consumption of the refrigerant circuit by increasing pressure of the refrigerant at an inlet of the compressor 104. The ejector 114 is further described in detail herein below with reference to FIG. 3. The first set of DCVs includes a primary DCV 110A configured to couple with the first heat exchanger 106A, a secondary DCV 110B configured to couple with the primary DCV 110A and the second heat exchanger 106B, an ejector DCV 110C configured to couple with the output 114C of the ejector 114, a compressor input DCV 110D configured to couple with the input of the compressor 104, a compressor output DCV 110E configured to couple with an output of the compressor 104, and a reference DCV 110F configured to couple with the compressor input DCV 110D, the first heat exchanger 106A, the second heat exchanger 106B and the third heat exchanger 106C.

The refrigerant circuit of the BTMS 100 further includes the plurality of throttling valves corresponding to the plurality of heat exchangers such as the first heat exchanger 106A, the second heat exchanger 106B, and the third heat exchanger 106C. In the present disclosure, the plurality of throttling valves includes a first throttling valve 108A configured to couple with the output 114C of the ejector 114 and the compressor 104 and an input of the third heat exchanger 106C. In an embodiment, an input of the first throttling valve 108A is coupled to the ejector DCV 110C and the compressor output DCV 110E and an output thereof is coupled to the third heat exchanger 106C. The plurality of throttling valves further include a second throttling valve 108B and a third throttling valve 108C configured to couple with inputs of the first heat exchanger 106A and the second heat exchanger 106B, respectively. The second throttling valve 108B and the third throttling valve 108C are further configured to couple with the reference DCV 110F and the compressor output DCV 110E via the on/off valve 112. During an operation of the BTMS 100, the first throttling valve 108A, the second throttling valve 108B, and the third throttling valve 108C reduce a temperature and a pressure of the refrigerant entering the third heat exchanger 106C, the first heat exchanger 106A, and the second heat exchanger 106B, respectively, to a desired operating condition thereof based on the operating modes of the BTMS 100. Each of the first throttling valve 108A, the second throttling valve 108B, and the third throttling valve 108C receives a saturated or slightly subcooled liquid refrigerant at a high temperature and a pressure and outputs a dual-phase refrigerant at low temperature and low pressure based on the operating modes of the BTMS 100. The temperature and pressure of output refrigerant of one throttling valve may be different from the temperature and pressure of output refrigerant of the other two throttling valves. For example, the temperature and pressure of the output refrigerant of the first throttling valve 108A may be different from the temperature and pressure of the output refrigerant of the second and third throttling valves 108B, 108C. Similarly, the temperature and pressure of the output refrigerant of the second throttling valve 108B may be different from the temperature and pressure of the output refrigerant of the first and third throttling valves 108A, 108C and the temperature and pressure of the output refrigerant of the third throttling valve 108C may be different from the temperature and pressure of the output refrigerant of the first and second throttling valves 108A, 108B.

The refrigerant circuit of the BTMS 100 further includes the on/off valve 112 configured to couple the compressor output DCV 110E with the second and third throttling valves 108B, 108C. The on/off valve 112 is further configured to allow flow of the refrigerant into the second and third throttling valves 108B, 108C without altering properties such as temperature and pressure of the refrigerant or prevent the refrigerant from entering the second and third throttling valves 108B, 108C. In an embodiment, during the cooling mode of the BTMS 100, the on/off valve 112 may prevent the refrigerant from flowing therethrough, while in the heating mode, the on/off valve 112 may allow the refrigerant to pass therethrough.

The coolant circuit is a closed loop through which a coolant of any type may flow to remove heat from the battery 102 or add heat to the battery 102 based on the desired operating condition of the EV. The coolant circuit includes the battery 102, a pump 116, a battery cooler 118, and a second set of directional control valves (DCVs). The battery 102 may be defined as an electric storage device that can provide required energy to wheels of the EV to facilitate driving. The battery 102 may be composed of many cells such as, but are not limited to, prismatic or cylindrical cells. The cells of the battery 102 may be composed of materials such as, but are not limited to, lithium-ion or nickel-metal hydride. The battery 102 further includes passages for allowing flow of the coolant therethrough. The passages are configured within the battery 102 in such a way to effectively control the operating temperature of the battery 102. The battery 102 may further include a plurality of sensors and flow meters for detecting various operating parameters of the battery 102 such as, but are not limited to, the operating temperature of the battery 102, temperature of the coolant, and flow rate of the coolant. The pump 116 of the coolant circuit may be of any type known to a person having ordinary skill in the art. The pump 116 is configured to move the coolant of the battery 102 around the coolant loop of the BTMS 100. The battery cooler 118 is defined as a sensible heat exchanger of any type known to a person having ordinary skill in the art. The battery cooler 118 is configured to reject heat from the coolant to a cold environment to lower a temperature of the coolant circulating through the coolant circuit. The battery cooler 118 may be in a crossflow relation with air drawn from outside, and a fan (not shown) installed for the third heat exchanger 106C may be used for the battery cooler 118 to enhance airflow and heat transfer rate. The battery cooler 118 receives the coolant from the pump 116 at a temperature higher than an optimal battery temperature range and outputs the coolant at a lower temperature suitable for optimal performance of the battery 102. Further, the battery cooler 118 receives air from the environment by the fan or due to movement of the EV with respect to a crossflow arrangement having the coolant flowing inside conduits of the battery cooler 118, where it dissipates heat from the coolant and outputs air at a higher temperature. The battery cooler 118 and the third heat exchanger 106C are close to each other, and the fan for the third heat exchanger 106C can operate with the battery cooler 118.

During the operation of the BTMS 100, the second set of DCVs may be controlled to direct a flow of the coolant through the coolant circuit to cool or heat the battery 102 as per the desired operating condition of the EV. The second set of DCVs includes a battery output DCV 120B configured to couple an output of the battery 102 with the battery cooler 118 and the second heat exchanger 106B, and a battery input DCV 120A, which is alternatively referred to as a four-way valve, configured to couple an input of the battery 102 with the battery cooler 118 and the second heat exchanger 106B. Further, the battery input DCV 120A and the battery output DCV 120B are coupled to each other. The four-way valve 120A includes three inlet ports configured to couple with the battery output DCV 120B, the second heat exchanger 106B and the battery cooler 118 and one outlet port configured to couple with the battery 102.

The directional control valves (DCVs) are configured to direct an input refrigerant or an input coolant to exit either in an axial direction or a transverse direction based on the operating modes of the BTMS 100. The transverse or axial directions may communicate the input refrigerant or the input coolant to a single opening in a valve assembly of the DCV without altering properties such as temperature or pressure of the refrigerant or the coolant. The DCVs may be configured to allow the input refrigerant or the input coolant to communicate with a specific output direction while blocking other path by actuating input or output gates.

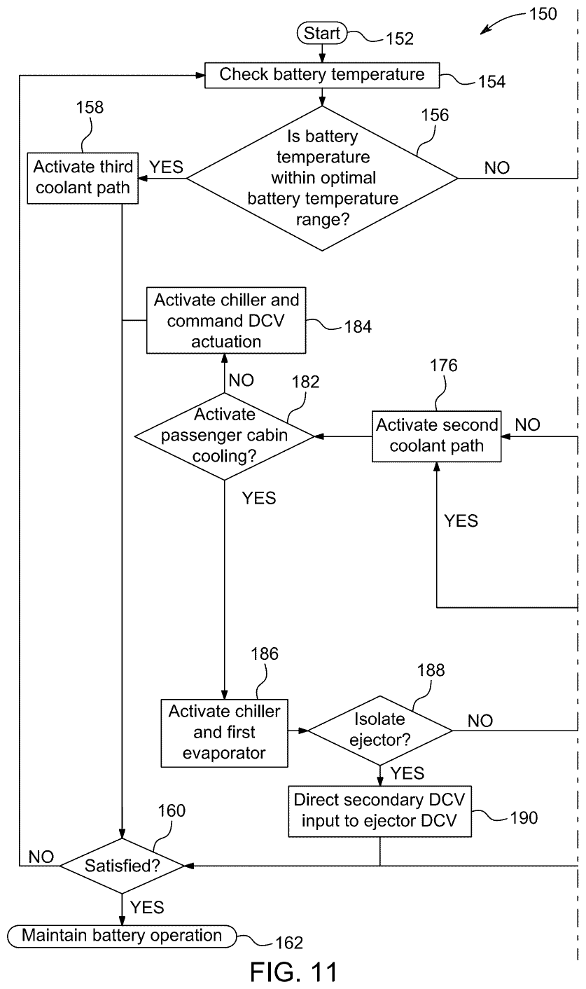

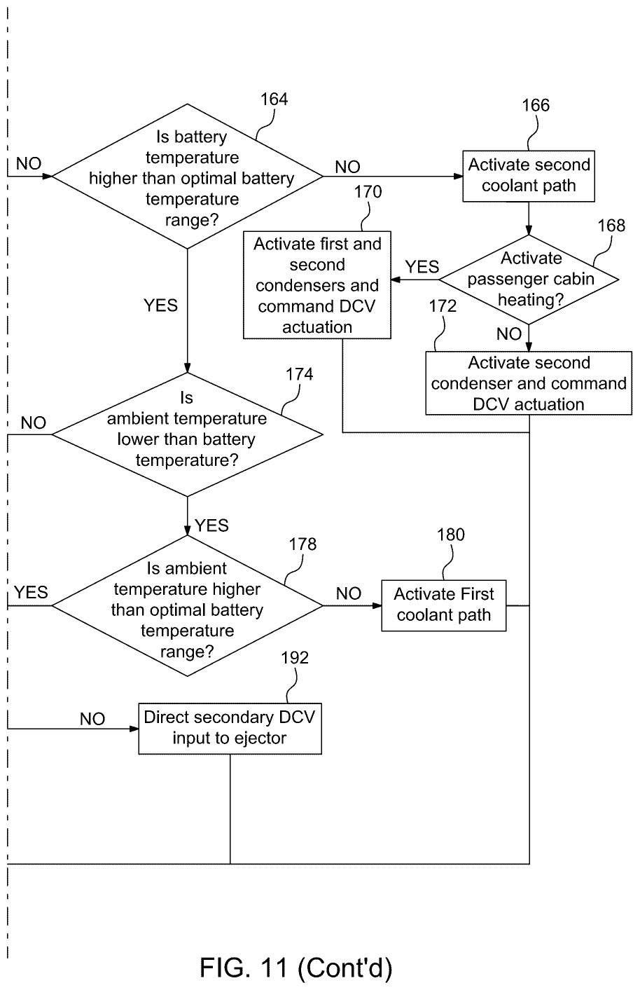

The BTMS 100 further includes a controller 130 configured to monitor and control the heating mode and the cooling mode of the BTMS 100 for optimal performance of the battery 102. The controller 130 is configured to be in communication with the first and second set of DCVs, the compressor 104, the plurality of throttling valves, the on/off valve 112, the pump 116, the battery 102, and the passenger cabin to control the operation of the BTMS 100. In an embodiment, the controller 130 is configured to control the primary DCV 110A, the secondary DCV 110B, the ejector DCV 110C, the compressor input DCV 110D, the compressor output DCV 110E, the reference DCV 110F, the battery input DCV 120A and the battery output DCV 120B based on the optimal battery temperature range of the battery 102, a coolant temperature of the battery 102, an ambient temperature of the EV, a passenger cabin temperature of the passenger cabin, an optimal passenger cabin temperature range of the passenger cabin, driving style of the EV and the HEV, terrain, and road conditions to achieve optimal temperature control of the battery 102. In an embodiment, actuation of the various elements of the BTMS 100 may be done using various controllers such as, but are not limited to, proportional controllers, integral-derivative controllers, or proportional-integral-derivative controllers. In a nonlimiting example, the optimal battery temperature range of the battery 102 may be between 15° C. to 40° C. In the coolant circuit, based on predefined program instructions and various operating parameters of the BTMS 100 such as, but are not limited to, the ambient temperature, the coolant temperature, the operating temperature of the battery 102, and the optimal battery temperature range, the controller 130 may determine an active coolant path to cool or heat the battery 102. A method of controlling the operations of the BTMS 100 by the controller 130 is descried in detail with reference to FIG. 11.

As shown in FIG. 1, the cooling mode of the BTMS 100 is illustrated, according to an embodiment of the present disclosure. For the illustration purpose of the cooling mode of the BTMS 100, the first heat exchanger 106A is referred to as the first evaporator 106A, the second heat exchanger 106B is referred to as the chiller 106B, and the third heat exchanger 106C is referred to as the third condenser 106C. An evaporator is defined as a latent heat exchanging device configured to receive heat from ambient air contained in a closed space or an open space. According to the present disclosure, the first evaporator 106A is configured to condition the passenger cabin of the EV to control comfortable temperature level of passengers. The first evaporator 106A may be in a crossflow relation with the air drawn from the passenger cabin and a fan may be mounted upstream with respect to an air flow direction to increase flow of air, both of which may enhance heat transfer and comfort control. The first evaporator 106A receives the refrigerant at a dual-phase state at a low temperature and low pressure from the second throttling valve 108B and outputs a saturated vapor or slightly superheated refrigerant at low pressure and low temperature. Further, the first evaporator 106A receives air from the passenger cabin in a crossflow relation with a flowing direction of the refrigerant inside conduits of the first evaporator 106A in such a way that the air rejects heat to the first evaporator 106A and outputs air at a low temperature.

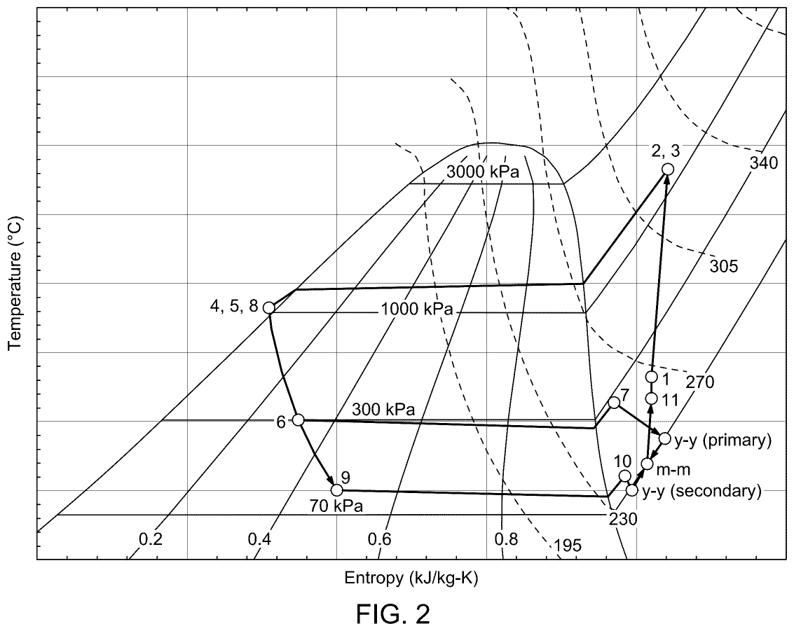

The refrigerant circuit includes the vapor compression refrigeration system having the ejector 114 to reduce power consumption of the compressor 104 by increasing pressure of the refrigerant at the inlet of the compressor 104. The primary DCV 110A is configured to couple the first evaporator 106A to the primary inlet 114A of the ejector 114, the secondary DCV 110B is configured to couple the chiller 106B to the secondary inlet 114B of the ejector 114, and the ejector DCV 110C is configured to couple the output 114C of the ejector 114 to the compressor input DCV 110D. The compressor input DCV 110D is configured to couple the ejector DCV 110C to the compressor 104, the compressor output DCV 110E is configured to couple the compressor 104 to the third condenser 106C, and the reference DCV 110F is configured to couple the third condenser 106C to at least one of the first evaporator 106A and the chiller 106B. The cooling mode of the BTMS 100 is further described with reference to a temperature-entropy diagram shown in FIG. 2, and thermodynamic states of the BTMS 100 are described with reference to FIG. 1 and FIG. 2.

The refrigerant (in vapor phase) entering the compressor 104 (at state 1) is compressed to a high temperature and a high pressure (at state 2). In an embodiment, the compressor 104 receives the refrigerant from the ejector 114 and exits high pressure and high temperature refrigerant. The compressor 104 increases a temperature and a pressure of the refrigerant to facilitate heat rejection therefrom and provides circulation of the refrigerant in the refrigerant circuit. Before entering the third condenser 106C, the refrigerant passes through the first throttling valve 108A (at state 3) which is fully opened to allow flow of the refrigerant without changing the properties such as the temperature and pressure of the refrigerant. According to the present disclosure, the first throttling valve 108A is configured to throttle the refrigerant in the heating mode of the BTMS 100. The refrigerant is further cooled in the third condenser 106C sensibly to become saturated vapor and condensation occurs to become a saturated liquid (at state 4). The third condenser 106C cools the refrigerant by exchanging heat with the ambient air. Due to friction inside tubes of the third condenser 106C, a pressure drop may occur, which may further lead to sub-cooling of the refrigerant. The third condenser 106C may be defined as a latent heat exchanging device configured to reject heat to the ambient by condensing the refrigerant received from the compressor 104. In an embodiment, the third condenser 106C may be in a crossflow relation with the ambient air and the fan can be mounted upstream with respect to a direction of airflow to increase the airflow, both of which enhance heat rejection rate. The third condenser 106C receives the refrigerant from the compressor 104 in a superheated state at high pressure and high temperature and results in a liquid refrigerant at high pressure and high temperature, which can be a saturated or subcooled liquid. Further, the third condenser 106C receives air from the ambient by the fan or due to movement of the EV in a crossflow arrangement having the refrigerant flowing inside conduits of the third condenser 106C where the air absorbs heat from the refrigerant and outputs air at a higher temperature.

After the third condenser 106C, the refrigerant is divided into an evaporator stream through the second throttling valve 108B (at state 5) and a chiller stream through the third throttling valve 108C (at state 8). The second throttling valve 108B and the third throttling valve 108C are used to reduce the temperature and pressure of the refrigerant to be compatible with the first evaporator 106A and the chiller 106B, respectively. Since outlet conditions of the first evaporator 106A and the chiller 106B cannot be precisely controlled, a small amount of superheating may appear at outlets of the first evaporator 106A and the chiller 106B (at states 7 and 10, respectively). Further, friction losses and pressure drop reduce pressure inside the first evaporator 106A and the chiller 106B.

The refrigerant coming from the first evaporator 106A is fed into the primary inlet 114A of the ejector 114 through the primary DCV 110A to facilitate supersonic flow at an outlet of a convergent-divergent nozzle 132 provided within the ejector 114, as shown in FIG. 3. Referring to FIG. 3, a schematic diagram of the ejector 114 is illustrated, according to an embodiment of the present disclosure. The ejector 114 is used to facilitate mixing of the evaporator stream and the chiller stream coming from the first evaporator 106A and the chiller 106B, respectively, and reduce power consumption of the refrigerant circuit by increasing the pressure of the refrigerant at the inlet of the compressor 104. As shown in FIG. 3, the ejector 114 includes a suction chamber 134, a constant area section 136, and a diffuser 138. The ejector 114 further includes the primary inlet 114A configured to couple to the first evaporator 106A through the primary DCV 110A, the secondary inlet 114B configured to couple to the chiller 106B and the primary DCV 110A through the secondary DCV 110B, and the output 114C configured to couple to the third condenser 106C and the compressor 104 through the ejector DCV 110C. The refrigerant coming from the first evaporator 106A is fed through the convergent-divergent nozzle 132 to increase speed thereof to supersonic flow. An outlet of the convergent-divergent nozzle 132 is a high-speed jet that enters the suction chamber 134 and thereby creates a low-pressure zone which draws the refrigerant from the chiller 106B to the suction chamber 134 when the refrigerant from the chiller 106B is fed into the secondary inlet 114B of the ejector 114. In an embodiment, the secondary inlet 114B is defined on an annular side of the suction chamber 134 and the primary inlet 114A is defined on the suction chamber 134 in an axial direction.

Due to difference in speed between the evaporator stream and the chiller stream at an exit of the convergent-divergent nozzle 132, a low-pressure zone is created, and a flow of the refrigerant coming through the secondary inlet 114B (otherwise referred to as a secondary flow) accelerates to a supersonic speed to be in contact with a flow of the refrigerant coming through the primary inlet 114A (otherwise referred to as a primary flow). Transfer of momentum from the primary flow of the refrigerant to the secondary flow of the refrigerant reduces speed thereof, and when both the evaporator and chiller streams are at the same velocity, mixing occurs in the constant area section 136. After mixing, the flow of refrigerant decelerates and undergoes a shock 140. The flow of the refrigerant may be subsonic before entering the diffuser 138. The diffuser 138 further decelerates the flow of the refrigerant and increases a pressure thereof. The refrigerant further leaves the ejector 114 at a higher pressure (at the state 1) than the secondary flow coming from the chiller 106B, and thereby reduces a load on the compressor 104. The states labelled as y-y and m-m within the ejector 114 are also illustrated in FIG. 2.

The coolant loop of the BTMS 100 is in direct contact with the battery 102 of the EV to maintain the operating temperature thereof within the optimal battery temperature range. In the cooling mode, the coolant circuit includes the battery output DCV 120B configured to couple the battery 102 to the chiller 106B or to the battery input DCV 120A and the battery input DCV 120A configured to couple the battery output DCV 120B or the chiller 106B to the battery 102. The pump 116 of the coolant circuit is coupled to an outlet of the battery 102 such that the coolant can be pumped at desired volume and pressure based on the operating temperature of the battery 102. During the cooling mode, the coolant enters the chiller 106B (at state 12) and leaves the chiller 106B (at state 13) such that heat from the coolant is removed by the refrigerant flowing through the chiller 106B to control the operating temperature of the battery 102. The chiller 106B may be defined as a latent heat exchanging device configured to accept heat from the coolant of the battery 102 to maintain the operating temperature of the battery 102 within the optimal battery temperature range. The chiller 106B may be in a concurrent, counter current, or crossflow relation with the coolant pumped from the battery 102. In such a case, the chiller 106B receives the coolant such as, but are not limited to, ethylene glycol-water mixture at an elevated temperature for exchanging sensible heat with the refrigerant flowing inside chiller conduits such that the temperature of the coolant at an outlet of the chiller 106B becomes lower than an inlet thereof. Simultaneously, the chiller 106B receives a dual-phase refrigerant at a low temperature and pressure and outputs a saturated vapor or slightly superheated refrigerant at low temperature and low pressure. The refrigerant absorbs sensible heat from the coolant which is used to vaporize the refrigerant that flows through the chiller conduits. The purpose of the chiller 106B is to provide rapid cooling to the battery 102 in case of high charging/discharging rates due to driving conditions, terrain, or acceleration/deceleration.

The battery input DCV 120A and the battery output DCV 120B help to direct the coolant in different pathways of the coolant circuit depending on various internal and external parameters such as an initial temperature of the battery 102, driving style and terrain, and the ambient temperature of the EV. In one example, if the coolant temperature of the battery 102 is higher than the optimal battery temperature range and the ambient temperature is lower than the coolant temperature, then the coolant is directed to the battery cooler 118 through a first coolant path ‘A’. In an embodiment, the battery cooler 118 is an air-cooled heat exchanger. The first coolant path ‘A’ utilizes colder environment to reduce a cooling load in the BTMS 100 since the pump 116 is operated instead of the compressor 104. In another example, when the coolant temperature is higher than the optimal battery temperature range and the ambient temperature is higher than the optimal battery temperature range, as in summer, the coolant is directed to the chiller 106B through a second coolant path ‘B’. In such a case, the refrigerant circuit is operated by circulating the refrigerant in the chiller 106B, enabling rapid cooling of the coolant to reduce the operating temperature of the battery 102. In yet another example, if the coolant temperature is within the optimal battery temperature range, then the controller 130 may bypass the BTMS 100 and intermittently circulate the coolant around the battery 102 through a third coolant path ‘C’ to stabilize and maintain the operating temperature of the battery 102 within the optimal battery temperature range. If the coolant temperature of the battery 102 is less than the optimal battery temperature range and the ambient temperature is also less, then the BTMS 100 may be operated in the heating mode to increase the coolant temperature to the optimal battery temperature range.

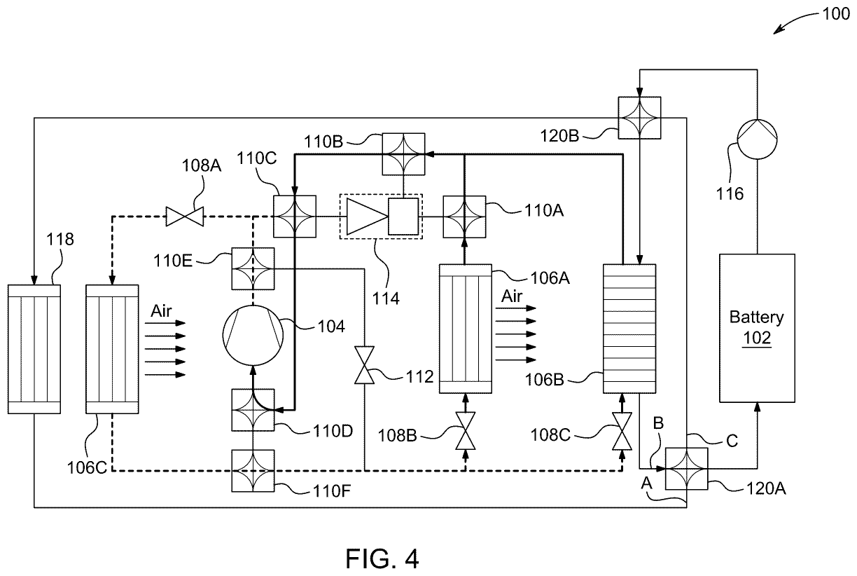

In some embodiments, as shown in FIG. 4, the primary DCV 110A, the secondary DCV 110B and the ejector DCV 110C may be controlled by the controller 130 to isolate the ejector 114 from the refrigerant circuit. In such a case, the primary DCV 110A and the secondary DCV 110B may be controlled to prevent flow of the refrigerant into the ejector 114 and the refrigerant coming from the first evaporator 106A is mixed with the refrigerant coming from the chiller 106B before entering the secondary DCV 110B. In an embodiment, the primary DCV 110A is configured to couple the first evaporator 106A to the secondary DCV 110B, the secondary DCV 110B is configured to couple the primary DCV 110A and the chiller 106B to the ejector DCV 110C, and the ejector DCV 110C is configured to couple the secondary DCV 110B to the compressor input DCV 110D. Further, the mixed stream of the evaporator stream and the chiller stream is allowed to communicate with the compressor 104 though the ejector DCV 110C.

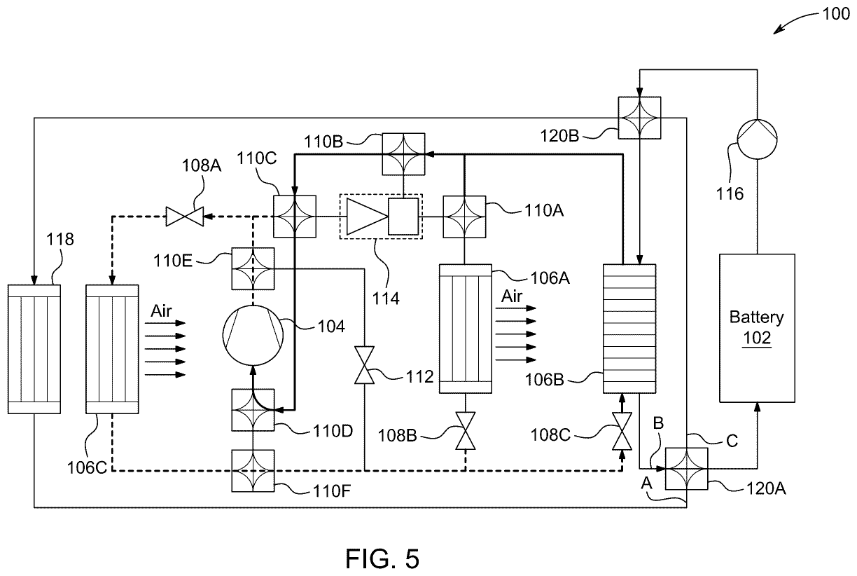

In some embodiments, as shown in FIG. 5, when only the battery 102 needs cooling and the passenger cabin does not require cooling, the first evaporator 106A and the ejector 114 may be isolated from the BTMS 100, and the entire refrigerant is directed to the chiller 106B. In such a case, the controller 130 actuates the second throttling valve 108B to close such that flow of the refrigerant to the first evaporator 106A is prevented and the entire refrigerant is allowed to flow through the chiller 106B. Further, the refrigerant coming from the chiller 106B is allowed to flow into the compressor 104 through the secondary DCV 110B and the ejector DCV 110C. Therefore, the chiller 106B may remove the heat from the coolant flowing therethrough to cool the coolant temperature and thereby reduce the operating temperature of the battery 102. Consequently, a thermal load on the battery 102, which is generally less than the first evaporator 106A, may reduce the power consumption of the BTMS 100.

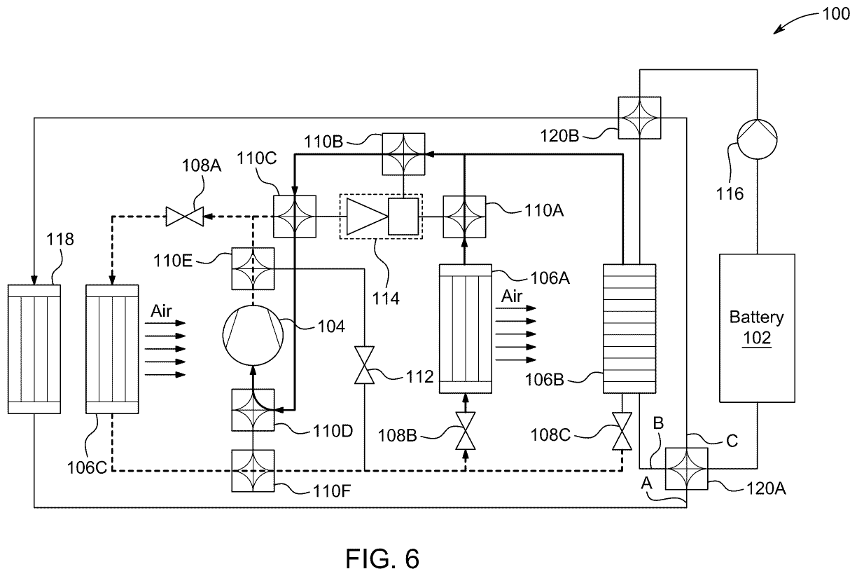

In some embodiments, as shown in FIG. 6, when only the passenger cabin needs cooling and the battery 102 does not require cooling, the chiller 106B and the ejector 114 may be isolated from the BTMS 100, and the entire refrigerant is directed to the first evaporator 106A. In such a case, the controller 130 actuates the third throttling valve 108C to close such that flow of the refrigerant to the chiller 106B is prevented and the entire refrigerant is allowed to flow through the first evaporator 106A. Further, the refrigerant coming from the first evaporator 106A is allowed to flow into the compressor 104 through the primary DCV 110A, the secondary DCV 110B and the ejector DCV 110C, such that the first evaporator 106A helps to cool the passenger cabin of the EV. The first coolant path ‘A’ or the third coolant path ‘C’ may be used by actuating the battery input DCV 120A and the battery output DCV 120B by the controller 130 if the ambient temperature is sufficient to maintain the operating temperature of the battery 102 within the optimal battery temperature range.

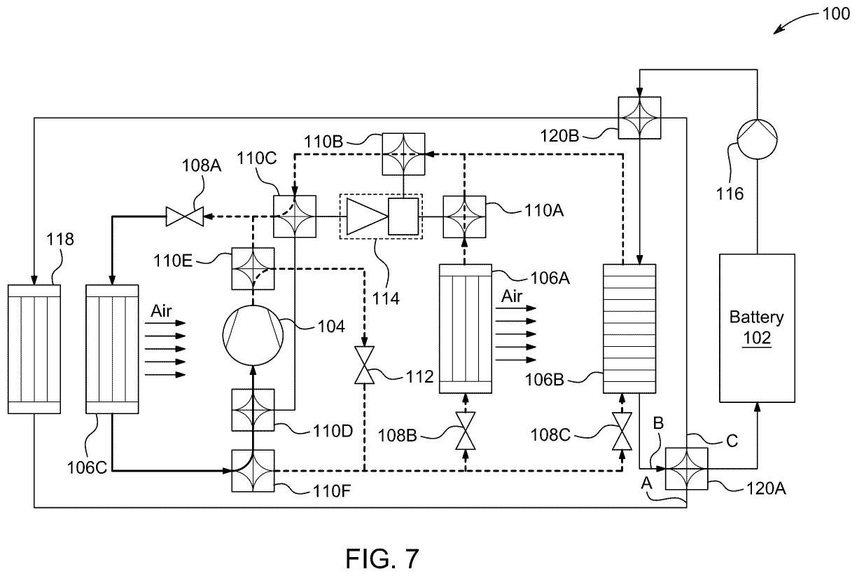

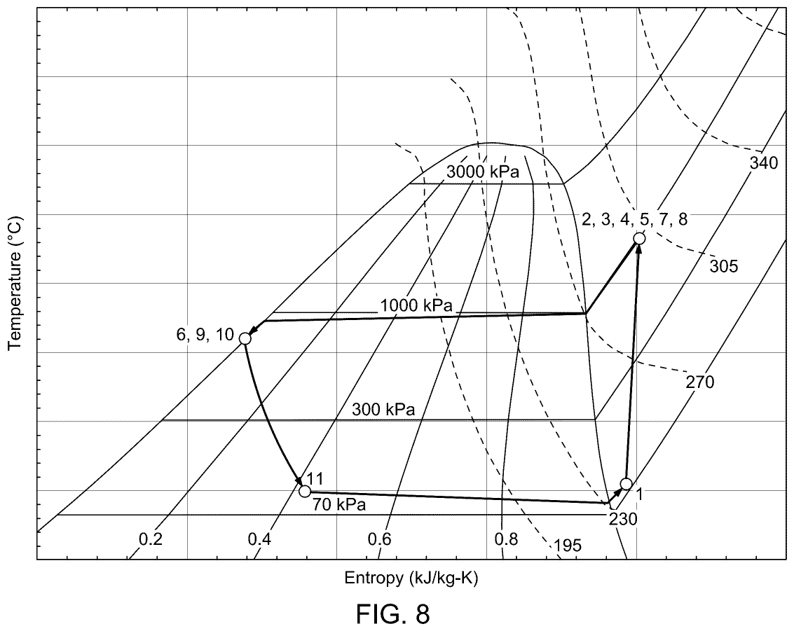

Referring to FIG. 7, a schematic block diagram of the BTMS 100 operating in the heating mode is illustrated, according to an embodiment of the present disclosure. For the illustration purpose of the heating mode of the BTMS 100, the first heat exchanger 106A is referred to as the first condenser 106A, the second heat exchanger 106B is referred to as the second condenser 106B, and the third heat exchanger 106C is referred to as the second evaporator 106C. The refrigerant circuit includes the vapor compression refrigeration system. The heating mode of the BTMS 100 is implemented when the operating temperature of the battery 102 is less than the optimal battery temperature range and the ambient temperature is less than the optimal battery temperature range. The heating mode of the BTMS 100 is achieved by controlling the plurality of DCVs associated with the refrigerant circuit to direct the refrigerant to the first condenser 106A, the second condenser 106B, the second evaporator 106C, and the compressor 104. In an embodiment, the primary DCV 110A is configured to couple the first condenser 106A to the secondary DCV 110B, the secondary DCV 110B is configured to couple the primary DCV 110A and the second condenser 106B to the ejector DCV 110C, and the ejector DCV 110C is configured to couple the secondary DCV 110B to the second evaporator 106C. The compressor input DCV 110D is configured to couple the reference DCV 110F to the compressor 104, the compressor output DCV 110E is configured to couple the compressor 104 to at least one of the first condenser 106A and the second condenser 106B, and the reference DCV 110F is configured to couple the second evaporator 106C to the compressor input DCV 110D. The refrigerant from the compressor 104 is directed to the first condenser 106A and the second condenser 106B to communicate the high temperature refrigerant vapor with the air of the passenger cabin and the coolant of the battery 102, respectively. As a result, the coolant temperature increases and thereby increases the operating temperature of the battery 102 to maintain within the optimal battery temperature range. In addition, the ejector 114 is isolated from the BTMS 100 by controlling the plurality of DCVs. Further, the second throttling valve 108B, the third throttling valve 108C, and the on/off valve 112 are fully opened to allow the refrigerant to flow therethrough. Similarly, the first throttling valve 108A is activated to reduce the high temperature and high pressure of the refrigerant coming from the first and second condensers 106A, 106B to a desired operating condition of the second evaporator 106C. The heating mode of the BTMS 100 is further described with reference to a temperature-entropy diagram shown in FIG. 8 and thermodynamic states of the BTMS 100 in the heating mode is described with reference to FIG. 7 and FIG. 8.

The refrigerant (in vapor phase) entering the compressor 104 (at state 1) is compressed to a high temperature and a high pressure (at state 2). After entering the compressor 104 (at state 2), the refrigerant passes through the on/off valve 112 (at state 3) which is fully opened to allow flow of the refrigerant without changing the properties such as the temperature and the pressure. The refrigerant is further divided into a first condenser stream through the second throttling valve 108B (at state 4) and a second condenser stream through the third throttling valve 108C (at state 7). The second throttling valve 108B and the third throttling valve 108C are fully opened and do not change properties of the refrigerant such as the temperature and pressure (i.e., the states 4 and 7 are identical to states 5 and 8, respectively). The refrigerant is further cooled in the first and second condensers 106A, 106B sensibly to become saturated vapor and condensation occurs to become a saturated liquid (at states 6 and 9). The first condenser 106A cools the refrigerant by exchanging heat with the ambient air of the passenger cabin whereas the second condenser 106B transfers heat to the coolant of the battery 102. Due to friction inside tubes of each of the first and second condensers 106A, 106B, a pressure drop may occur, which may further lead to sub-cooling of the refrigerant. After passing through the first condenser 106A, the first condenser stream is allowed to pass through the primary DCV 110A and mixed with the second condenser stream coming from the second condenser 106B before entering the secondary DCV 110B. The mixed refrigerant stream is further allowed to enter into the first throttling valve 108A (at state 10) through the ejector DCV 110C. The first throttling valve 108A is activated by the controller 130 to reduce the saturated high temperature and high pressure of the refrigerant to a low temperature and low pressure two-phase refrigerant compatible with a desired operating condition of the second evaporator 106C (at state 11). The second evaporator 106C, which is at a lower temperature than the ambient temperature, receives heat from the cold environment to vaporize the refrigerant. Since an outlet condition of the second evaporator 106C cannot be precisely controlled, a small amount of superheating may appear at the outlet of the second evaporator 106C (at state 1). Further, friction losses and pressure drop reduce the pressure inside the second evaporator 106C. After the second evaporator 106C, the refrigerant enters the compressor 104, and the cycle repeats.

The coolant loop of the BTMS 100 is in direct contact with the battery 102 of the EV to maintain the operating temperature thereof within the optimal battery temperature range. In the heating mode, the coolant circuit includes the battery output DCV 120B configured to couple the battery 102 to the second condenser 106B or to the battery input DCV 120A and the battery input DCV 120A configured to couple the battery output DCV 120B or the second condenser 106B to the battery 102. During the heating mode, the coolant follows the second coolant path ‘B’ in which the coolant enters the second condenser 106B (at state 12) and leaves the second condenser 106B (at state 13) such that the coolant receives heat from the refrigerant flowing through the second condenser 106B to increase the operating temperature of the battery 102. The battery input DCV 120A and the battery output DCV 120B are actuated by the controller 130 to direct flow of the coolant in the second coolant path ‘B’. The first coolant path ‘A’, the second coolant path ‘B’, and the third coolant path ‘C’ may be selectively operated by controlling the battery input DCV 120A and the battery output DCV 120B based on the coolant temperature of the battery 102. When the coolant temperature of the battery 102 is less than the optimal battery temperature range and the ambient temperature is also less, the BTMS 100 may be operated in the heating mode to increase the coolant temperature to the optimal battery temperature range.

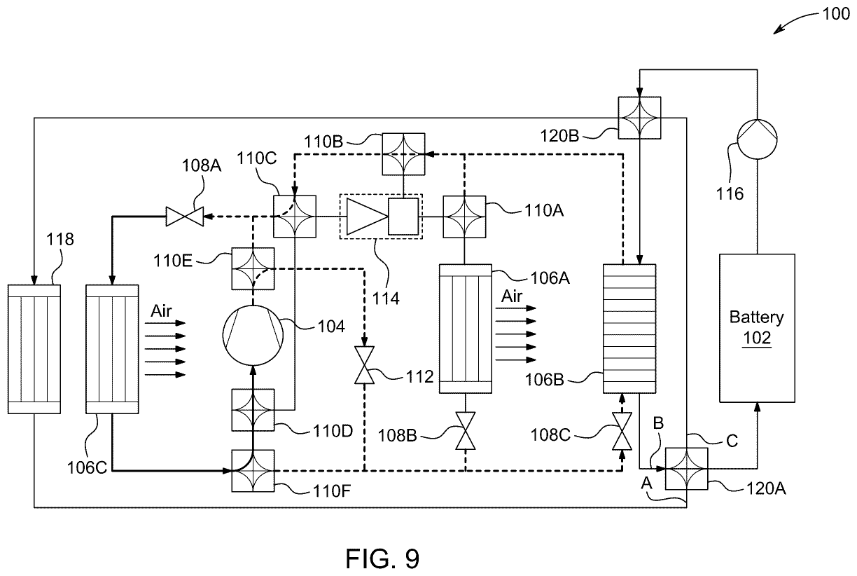

In some embodiments, as shown in FIG. 9, when only the battery 102 needs heating and the passenger cabin does not require heating, the first condenser 106A may be isolated from the BTMS 100, and the entire refrigerant is directed to the second condenser 106B. In such a case, the controller 130 actuates the second throttling valve 108B to close such that flow of the refrigerant to the first condenser 106A may be prevented and the entire refrigerant is allowed to flow through the second condenser 106B. Further, the refrigerant coming from the second condenser 106B is allowed to flow into the second evaporator 106C through the secondary DCV 110B and the ejector DCV 110C, such that the second condenser 106B may heat the coolant flowing therethrough and thereby increase the operating temperature of the battery 102. Consequently, a thermal load on the battery 102, which is generally less than the second evaporator 106C, may reduce the power consumption of the BTMS 100.

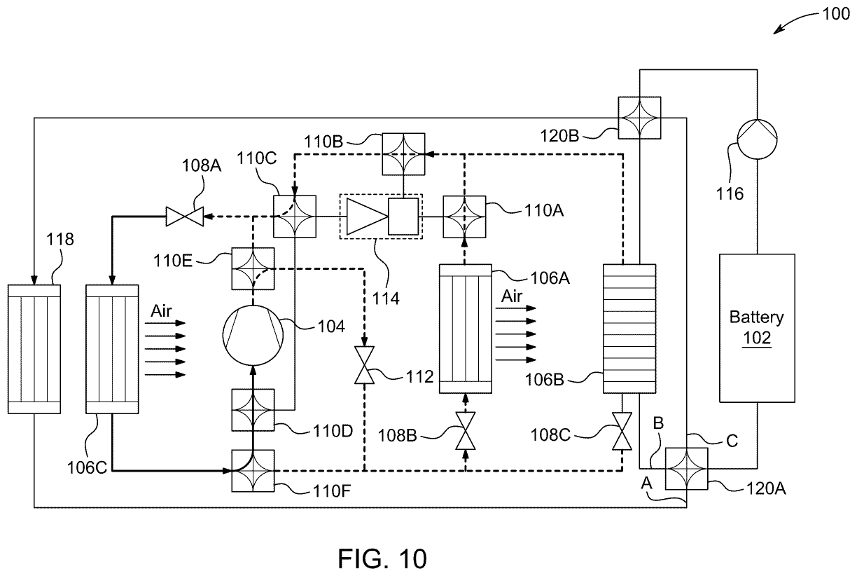

In some embodiments, as shown in FIG. 10, when only the passenger cabin needs heating and the battery 102 does not require heating, the second condenser 106B may be isolated from the BTMS 100, and the entire refrigerant is directed to the first condenser 106A. In such a case, the controller 130 actuates the third throttling valve 108C to close such that flow of the refrigerant to the second condenser 106B is prevented and the entire refrigerant is allowed to flow through the first condenser 106A. Further, the refrigerant coming from the first condenser 106A is allowed to flow into the second evaporator 106C through the primary DCV 110A, the secondary DCV 110B and the ejector DCV 110C, such that the first condenser 106A helps to heat the passenger cabin. The first coolant path ‘A’ or the third coolant path ‘C’ may be used by actuating the battery input DCV 120A and the battery output DCV 120B by the controller 130 if the ambient temperature is sufficient to maintain the operating temperature of the battery 102 within the optimal battery temperature range.

Referring to FIG. 11, a schematic flow diagram of a method 150 of operating the BTMS 100 implemented in the EV is illustrated, according to an embodiment of the present disclosure. In an embodiment, the operation of the BTMS 100 in both the cooling mode and the heating mode is explained in detail. At step 152, the EV is started, so the BTMS 100 to operate the battery 102 at a temperature within the optimal battery temperature range. At step 154, the controller 130 disposed in communication with the battery 102 detects the operating temperature of the battery 102 based on input signals indicative of various operating parameters of the battery 102 such as the battery temperature and the coolant temperature received from the plurality of sensors. In a nonlimiting example, the operating temperature of the battery 102 may be determined based on the coolant temperature. Therefore, the battery temperature may be alternatively referred to as the coolant temperature. At step 156, the controller 130 is configured to compare the detected operating temperature of the battery 102 with the optimal battery temperature range. The optimal battery temperature range may be preset in the controller 130 or stored in a memory of the controller 130. Also, the optimal battery temperature range may be derived based on lab tests or various off-field or on-field experimental results of the EV. At step 158, the controller 130 is configured to activate the third coolant path ‘C’ when the detected operating temperature of the battery 102 is within the optimal battery temperature range. In an embodiment, when the coolant temperature is within the optimal battery temperature range, the controller 130 controls the battery output DCV 120B to couple the battery 102 to the battery input DCV 120A and controls the battery input DCV 120A to couple the battery output DCV 120B to the battery 102 such that output coolant from the battery 102 is circulated back to the battery 102 as input coolant without changing the properties of the coolant. At step 160, the controller 130 is configured to check the operating temperature of the battery 102 and, at step 162, if the operating temperature of the battery 102 is within the optimal battery temperature range, the controller 130 is configured to control the BTMS 100 to operate in the same mode to maintain the operating temperature of the battery 102 within the optimal battery temperature range. At step 164, the controller 130 is configured to check if the operating temperature of the battery 102 is higher than the optimal battery temperature range when the detected operating temperature of the battery 102 is not within the optimal battery temperature range. At step 166, the controller 130 is configured to activate the second coolant path ‘B’ when the detected operating temperature of the battery 102 is lower than the optimal battery temperature range. In an embodiment, when the coolant temperature is lower than the optimal battery temperature range and the ambient temperature is lower than the coolant temperature, the controller 130 is configured to operate the BTMS 100 in the heating mode, controls the battery output DCV 120B to couple the battery 102 to the second condenser 106B and controls the battery input DCV 120A to couple the second condenser 106B to the battery 102, such that the temperature of the battery 102 may be increased.

At step 168, the controller 130 is further configured to check if the passenger cabin needs heating. Requirements of passenger cabin heating may be determined based on operator inputs or input signals received from a plurality of sensors present in the passenger cabin. The input signals may be indicative of a temperature of the passenger cabin. At step 170, when the passenger cabin needs heating, the controller 130 is configured to control the BTMS 100 to operate in the heating mode as described with reference to FIG. 7. In an embodiment, the controller 130 controls the first set of DCVs, the plurality of throttling valves, and the on/off valve 112 to control flow of the high temperature and high pressure refrigerant through the first and second condensers 106A, 106B. As the high temperature and high pressure refrigerant flows through the first condenser 106A, the low temperature air present in the passenger cabin receives heat from the refrigerant and thereby increases temperature within the passenger cabin. Simultaneously, the high temperature and high pressure refrigerant flows through the second condenser 106B and thereby heats the coolant when the coolant circuit is configured to implement the second coolant path ‘B’. At step 172, when the controller 130 determines that the passenger cabin does not require heating, then the controller 130 controls the second throttling valve 108B, the primary DCV 110A and the secondary DCV 110B to isolate the first condenser 106A and the ejector 114 to allow the refrigerant to flow through only the second condenser 106B. In some embodiments, when the coolant temperature is lower than the optimal battery temperature range and the passenger cabin temperature is within an optimal passenger cabin temperature range, the controller 130 controls the second throttling valve 108B coupled between the first condenser 106A and the reference DCV 110F to be closed. The controller 130 further controls the primary DCV 110A to couple the first condenser 106A to the secondary DCV 110B, and controls the secondary DCV 110B to couple the primary DCV 110A and the second condenser 106B to the ejector DCV 110C. As such, only the coolant of the battery 102 is heated to maintain the operating temperature of the battery 102 within the optimal battery temperature range.

At step 174, the controller 130 is configured to determine if the ambient temperature is lower than the battery temperature when the controller 130 determines that the operating temperature of the battery 102 is higher than the optimal battery temperature range. The controller 130 may determine the ambient temperature based on input signals received from one or more sensors placed in the ambient. At step 176, when the controller 130 determines that the ambient temperature is not lower than the battery temperature, then the controller 130 actuates the second coolant path ‘B’ to reduce the temperature of the battery 102 by operating the BTMS 100 in the cooling mode thereof. In an embodiment, when the coolant temperature is higher than the optimal battery temperature range and the ambient temperature is higher than the coolant temperature, the controller 130 controls the BTMS 100 to operate in the cooling mode, controls the battery output DCV 120B to couple the battery 102 to the chiller 106B and controls the battery input DCV 120A to couple the chiller 106B to the battery 102. At step 178, the controller 130 is configured to determine if the ambient temperature is higher than the optimal battery temperature range when the controller 130 determines that the ambient temperature is lower than the battery temperature. At step 180, the controller 130 is configured to actuate the first coolant path ‘A’ when the controller 130 determines that the ambient temperature is lower than the optimal battery temperature range. In an embodiment, when the coolant temperature is higher than the optimal battery temperature range and the ambient temperature is lower than the optimal battery temperature range, the controller 130 controls the battery output DCV 120B to couple the battery 102 to the battery cooler 118 and controls the battery input DCV 120A to couple the battery cooler 118 to the battery 102 such that the first coolant path ‘A’ is activated to reduce the temperature of the battery 102. When the controller 130 determines that the ambient temperature is higher than the optimal battery temperature range at the step 178, then the controller 130 is configured to actuate the second coolant path ‘B’ as discussed in the step 176. In some embodiments, when the coolant temperature is higher than the optimal battery temperature range and the passenger cabin temperature is within the optimal passenger cabin temperature range, the controller 130 controls the second throttling valve 108B coupled between the first evaporator 106A and the reference DCV 110F to be closed. The controller 130 further controls the primary DCV 110A to couple the first evaporator 106A to the secondary DCV 110B, and controls the secondary DCV 110B to couple the primary DCV 110A and the chiller 106B to the ejector DCV 110C.

At step 182, the controller 130 is configured to check if the passenger cabin needs cooling. Requirements of passenger cabin cooling may be determined based on the operator inputs and the input signals received from the plurality of sensors present in the passenger cabin. The input signals may be indicative of the temperature of the passenger cabin. At step 184, when the passenger cabin needs cooling, the controller 130 is configured to control the BTMS 100 to operate in the cooling mode as described with reference to FIG. 1. In an embodiment, the controller 130 controls the first set of DCVs and the plurality of throttling valves 108 to control flow of the low temperature and low pressure refrigerant through the first evaporator 106A and the chiller 106B. As the low temperature and low pressure refrigerant flows through the first evaporator 106A, the high temperature air present in passenger cabin discharges heat to the refrigerant and thereby decreases temperature within the passenger cabin. Simultaneously, the low temperature and low pressure refrigerant flows through the chiller 106B and thereby cools the coolant when the coolant circuit is configured to implement the second coolant path ‘B’. At step 186, when the controller 130 determines that the passenger cabin does not require cooling, then the controller 130 controls the second throttling valve 108B, the primary DCV 110A and the secondary DCV 110B to isolate the first evaporator 106A and the ejector 114 to allow the refrigerant to flow through only the chiller 106B. In some embodiments, when the coolant temperature is higher than the optimal battery temperature range and the passenger cabin temperature is within the optimal passenger cabin temperature range, the controller 130 controls the second throttling valve 108B to be closed, controls the primary DCV 110A to couple the first evaporator 106A to the secondary DCV 110B, and controls the secondary DCV 110B to couple the primary DCV 110A and the chiller 106B to the ejector DCV 110C.

At step 188, when the controller 130 determines that both the passenger cabin and the battery 102 need cooling, the controller 130 is configured to check if the ejector 114 needs to be isolated. If the controller 130 determines that the ejector 114 needs to be isolated, then the controller 130 is configured to direct an input of the secondary DCV 110B to the ejector DCV 110C at step 190. Further, if the controller 130 determines that the ejector 114 need not be isolated, then the controller 130 is configured to direct an input of the secondary DCV 110B to the ejector 114 at step 192.

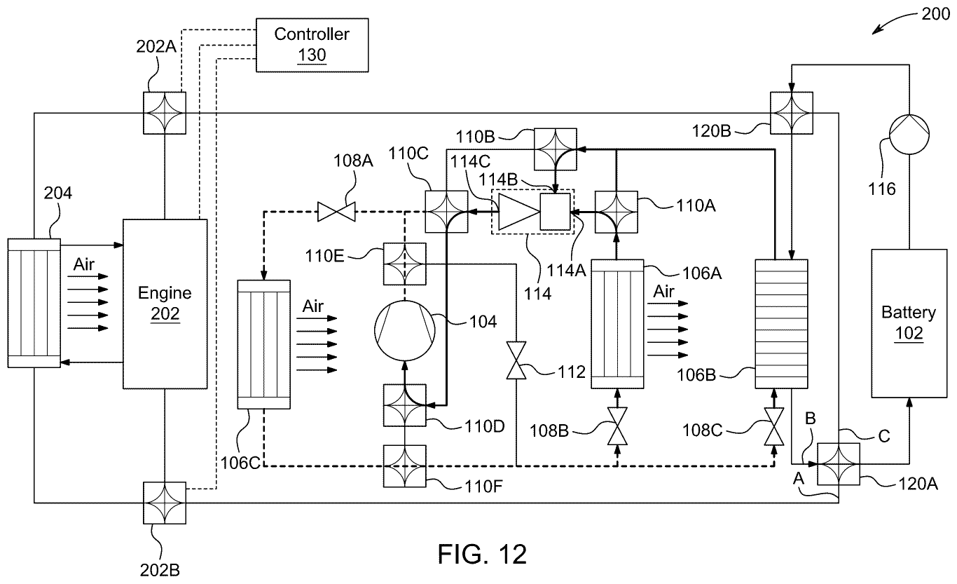

Referring to FIG. 12, a schematic block diagram of a BTMS 200 implemented in a hybrid electric vehicle (HEV) is illustrated, according to an embodiment of the present disclosure. In an embodiment, a cooling mode operation of the BTMS 200 is illustrated in detail. The BTMS 200 includes a refrigerant circuit having the primary DCV 110A configured to couple the first evaporator 106A to the primary inlet 114A of the ejector 114, the secondary DCV 110B configured to couple the chiller 106B to the secondary inlet 114B of the ejector 114, and the ejector DCV 110C configured to couple the output 114C of the ejector 114 to the compressor input DCV 110D. The compressor input DCV 110D is configured to couple the ejector DCV 110C to the compressor 104, the compressor output DCV 110E is configured to couple the compressor 104 to the third condenser 106C, and the reference DCV 110F is configured to couple the third condenser 106C to at least one of the first evaporator 106A and the chiller 106B. The controller 130 is configured to control the primary DCV 110A, the secondary DCV 110B, the ejector DCV 110C, the compressor input DCV 110D, the compressor output DCV 110E, and the reference DCV 110F further based on an engine operation of the HEV. The cooling mode operation and control strategies of the refrigerant circuit of the BTMS 200 is identical to the cooling mode operation of the refrigerant circuit of the BTMS 100 described with reference to FIG. 1, and, hence, the cooling mode operation of the refrigerant circuit of the BTMS 200 is avoided for the brevity in explanation.

The BTMS 200 further includes a coolant circuit having the battery 102, the battery input DCV 120A, the battery output DCV 120B, and the pump 116 as described in FIG. 1. The coolant circuit of the BTMS 200 is in direct contact with the battery 102 and an engine 202 of the HEV to maintain the operating temperature of the battery 102 within the optimal battery temperature range. In an embodiment, the coolant circuit of the BTMS 200 includes the engine 202 of the HEV, an engine input DCV 202A, an engine output DCV 202B, and a cooler 204. In one embodiment, a radiator of the engine 202 may act as the cooler 204 for cooing the coolant passing though the coolant circuit. In another embodiment, the cooler 204 may be separately attached to the radiator of the engine 202 for removing heat from the coolant flowing therethrough. The engine input DCV 202A is configured to couple the battery output DCV 120B with the cooler 204 and the engine 202. Similarly, the engine output DCV 202B is configured to couple the battery input DCV 120A with the cooler 204 and the engine 202. In the cooling mode, the coolant circuit includes the battery output DCV 120B configured to couple the battery 102 to the chiller 106B and the battery input DCV 120A configured to couple the chiller 106B to the battery 102. The controller 130 is configured to control the battery input DCV 120A and the battery output DCV 120B based on an engine operation of the HEV. In one example, if the coolant temperature of the battery 102 is higher than the optimal battery temperature range and the ambient temperature is lower than the coolant temperature, then the coolant is directed to the cooler 204 through a first coolant path ‘A’. Further, the engine input DCV 202A and the engine output DCV 202B may be controlled by the controller 130 to allow the coolant to flow through the first coolant path ‘A’. In another example, when the coolant temperature is higher than the optimal battery temperature range and the ambient temperature is higher than the optimal battery temperature range, as in summer, the coolant is directed to the chiller 106B through the second coolant path ‘B’. In yet another example, if the coolant temperature is within the optimal battery temperature range, then the controller 130 may bypass the BTMS 200 and intermittently circulate the coolant around the battery 102 through the third coolant path ‘C’ to stabilize and maintain the operating temperature of the battery 102 within the optimal battery temperature range.

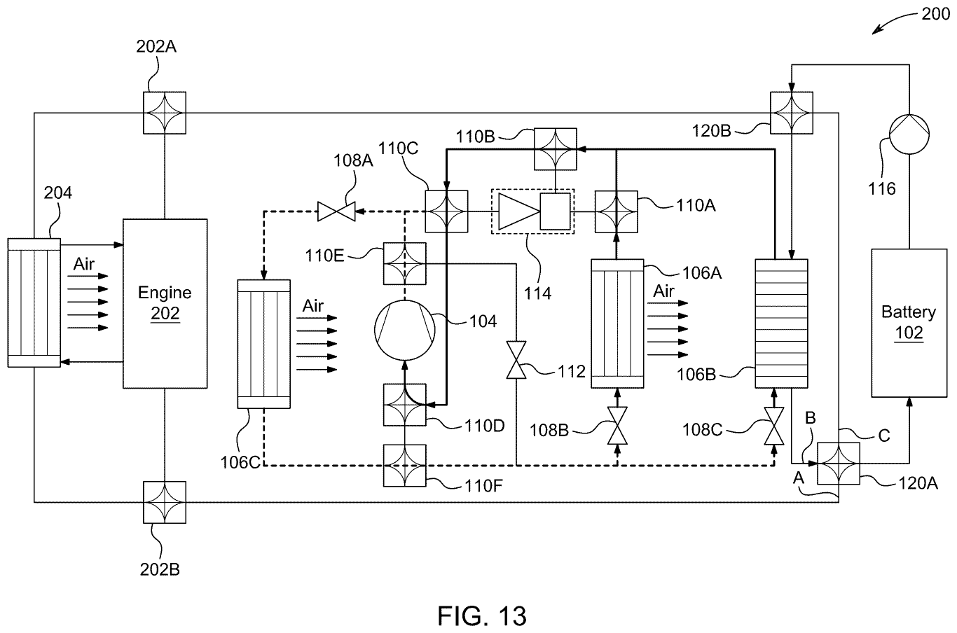

In some embodiments, as shown in FIG. 13, the primary DCV 110A, the secondary DCV 110B and the ejector DCV 110C are controlled by the controller 130 to isolate the ejector 114 from the refrigerant circuit. In an embodiment, the primary DCV 110A and the secondary DCV 110B may be controlled to prevent flow of the refrigerant into the ejector 114 and the refrigerant coming from the first evaporator 106A is mixed with the refrigerant coming from the chiller 106B before entering the secondary DCV 110B. The mixed stream of the evaporator stream and the chiller stream is allowed to communicate with the compressor 104 though the ejector DCV 110C.

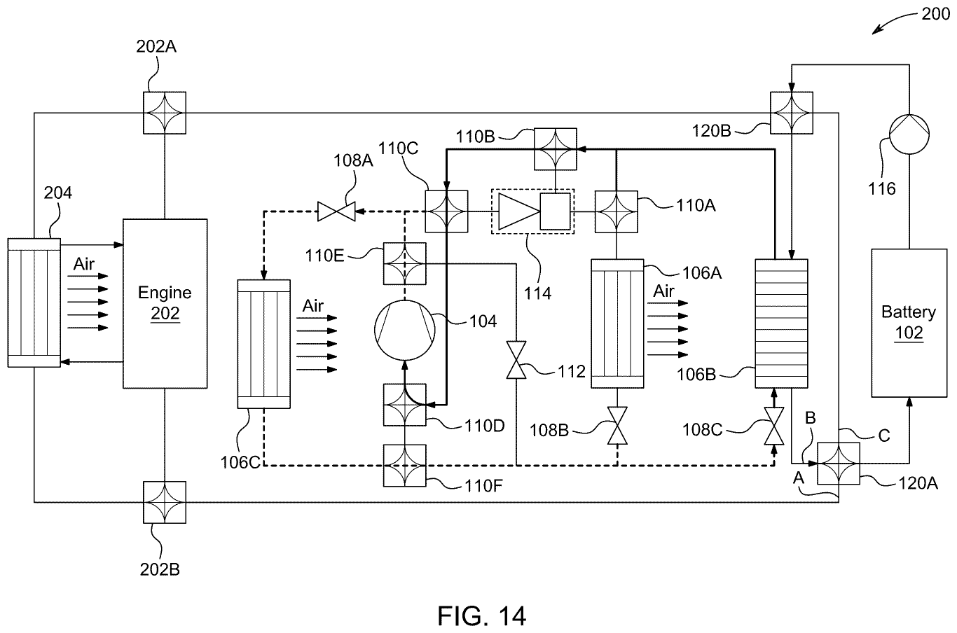

In some embodiments, as shown in FIG. 14, when only the battery 102 needs cooling and the passenger cabin of the HEV does not require cooling, the first evaporator 106A and the ejector 114 may be isolated from the BTMS 200, and the entire refrigerant is directed to the chiller 106B. In such a case, the controller 130 actuates the second throttling valve 108B to close such that flow of the refrigerant to the first evaporator 106A is prevented and the entire refrigerant is allowed to flow through the chiller 106B. Further, the refrigerant coming from the chiller 106B is allowed to flow into the compressor 104 through the secondary DCV 110B and the ejector DCV 110C. Such that the chiller 106B may remove the heat from the coolant flowing therethrough to cool the coolant temperature and thereby reduce the operating temperature of the battery 102. Consequently, the thermal load on the battery 102, which is generally less than the first evaporator 106A, may reduce the power consumption of the BTMS 200.

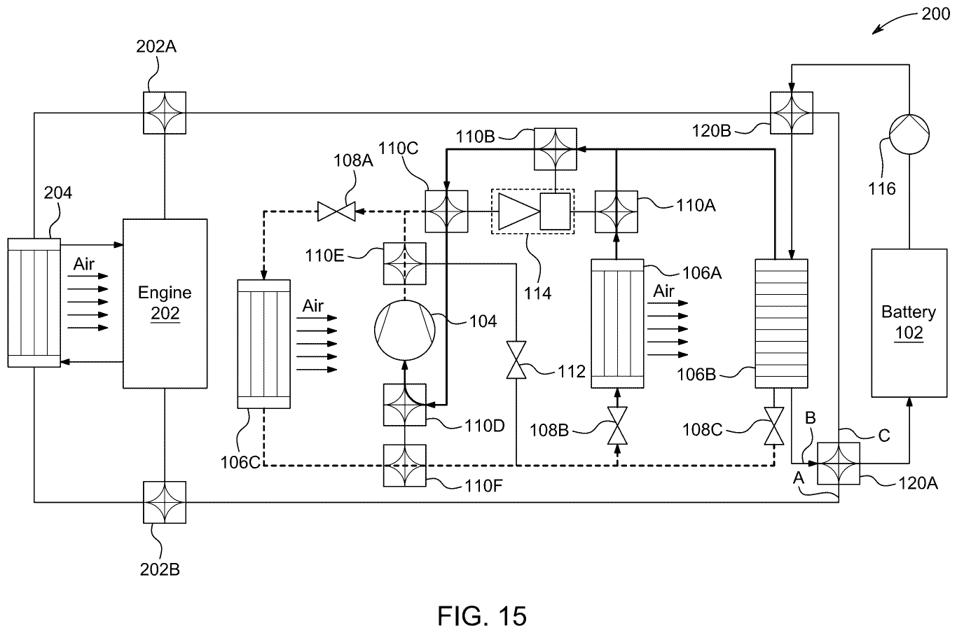

In some embodiments, as shown in FIG. 15, when only the passenger cabin of the HEV needs cooling and the battery 102 does not require cooling, the chiller 106B and the ejector 114 may be isolated from the BTMS 200, and the entire refrigerant is directed to the first evaporator 106A. In such a case, the controller 130 actuates the third throttling valve 108C to close such that flow of the refrigerant to the chiller 106B is prevented and the entire refrigerant is allowed to flow through the first evaporator 106A. Further, the refrigerant coming from the first evaporator 106A is allowed to flow into the compressor 104 through the primary DCV 110A, the secondary DCV 110B and the ejector DCV 110C, such that the first evaporator 106A helps to cool the passenger cabin of the HEV. The first coolant path ‘A’ or the third coolant path ‘C’ may be used by actuating the battery input DCV 120A and the battery output DCV 120B by the controller 130 if the ambient temperature is sufficient to maintain the operating temperature of the battery 102 within the optimal battery temperature range.

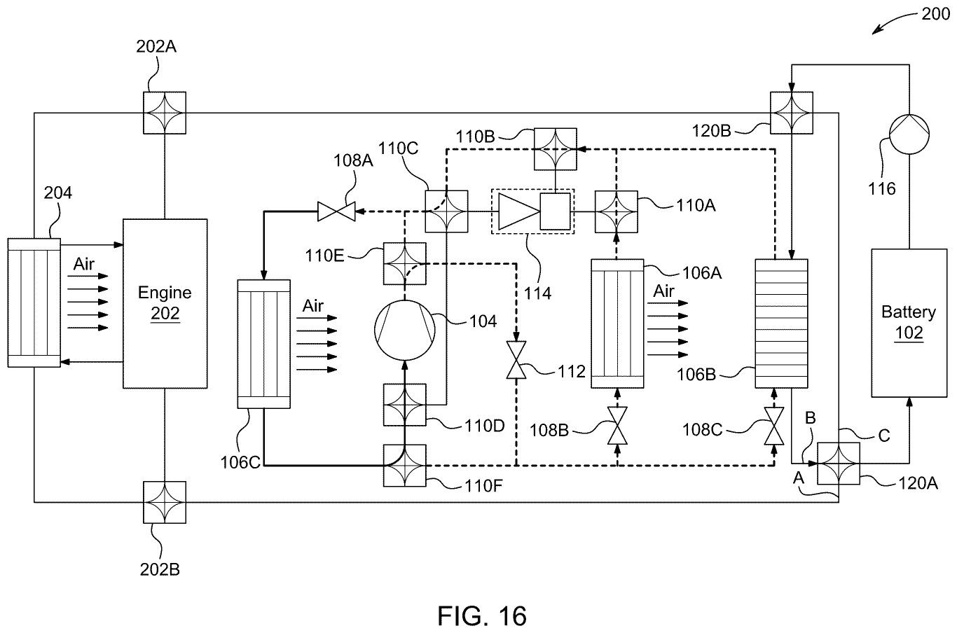

Referring to FIG. 16, a schematic block diagram of the BTMS 200 operating in the heating mode is illustrated, according to an embodiment of the present disclosure. The heating mode of the BTMS 200 is implemented when the operating temperature of the battery 102 is less than the optimal battery temperature range and the ambient temperature is less than the optimal battery temperature range. The refrigerant circuit of the BTMS 200 includes the primary DCV 110A configured to couple the first condenser 106A to the secondary DCV 110B, the secondary DCV 110B configured to couple the primary DCV 110A and the second condenser 106B to the ejector DCV 110C, and the ejector DCV 110C configured to couple the secondary DCV 110B to the second evaporator 106C. The compressor input DCV 110D is configured to couple the reference DCV 110F to the compressor 104, the compressor output DCV 110E is configured to couple the compressor 104 to at least one of the first condenser 106A and the second condenser 106B, and the reference DCV 110F is configured to couple the second evaporator 106C to the compressor input DCV 110D. The refrigerant from the compressor 104 is directed to the first condenser 106A and the second condenser 106B to communicate the high temperature refrigerant vapor with the air of the passenger cabin and the coolant of the battery 102, respectively. As a result, the coolant temperature increases and thereby increase the operating temperature of the battery 102 to maintain within the optimal battery temperature range. A temperature-entropy diagram associated with the heating mode of the BTMS 200 is identical to the temperature-entropy diagram of FIG. 8. Further, the heating mode operation of the refrigerant circuit of the BTMS 200 is identical to the heating mode operation of the refrigerant circuit of the BTMS 100 described with reference to FIG. 7 and hence the heating mode operation of the refrigerant circuit of the BTMS 200 is avoided for the brevity in explanation.

In the heating mode, the coolant circuit includes the battery output DCV 120B configured to couple the battery 102 to the second condenser 106B and the battery input DCV 120A configured to couple the second condenser 106B to the battery 102. During the heating mode, the coolant follows the second coolant path ‘B’ in which the coolant enters the second condenser 106B and leaves the second condenser 106B such that the coolant receives heat from the refrigerant flowing through the second condenser 106B to increase the operating temperature of the battery 102. The battery input DCV 120A and the battery output DCV 120B are actuated by the controller 130 to direct flow of the coolant in the second coolant path ‘B’. When the controller 130 determines that the operating temperature of the battery 102 is less than the optimal battery temperature range and a temperature of the engine 202 is greater than the optimal battery temperature range, then the controller 130 controls the engine input DCV 202A and the engine output DCV 202B to allow the heat generated by the engine 202 to transfer to the coolant flowing through the first coolant path ‘A’.

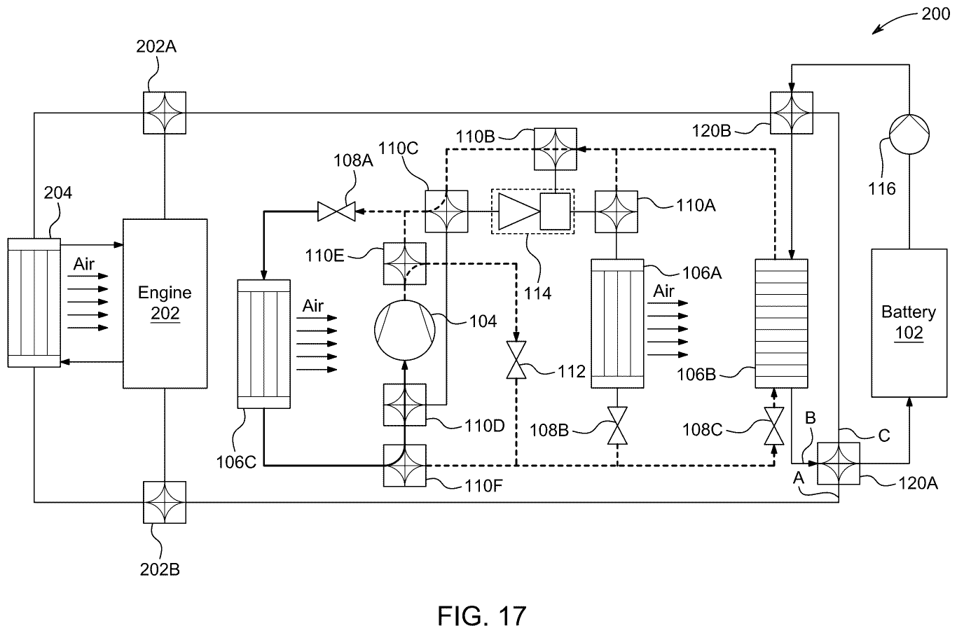

In some embodiments, as shown in FIG. 17, when only the battery 102 needs heating and the passenger cabin of the HEV does not require heating, the first condenser 106A may be isolated from the BTMS 200, and the entire refrigerant is directed to the second condenser 106B. In such a case, the controller 130 actuates the second throttling valve 108B to close such that flow of the refrigerant to the first condenser 106A may be prevented and the entire refrigerant is allowed to flow through the second condenser 106B. Further, the refrigerant coming from the second condenser 106B is allowed to flow into the second evaporator 106C through the secondary DCV 110B and the ejector DCV 110C, such that the second condenser 106B may heat the coolant flowing therethrough and thereby increase the operating temperature of the battery 102.

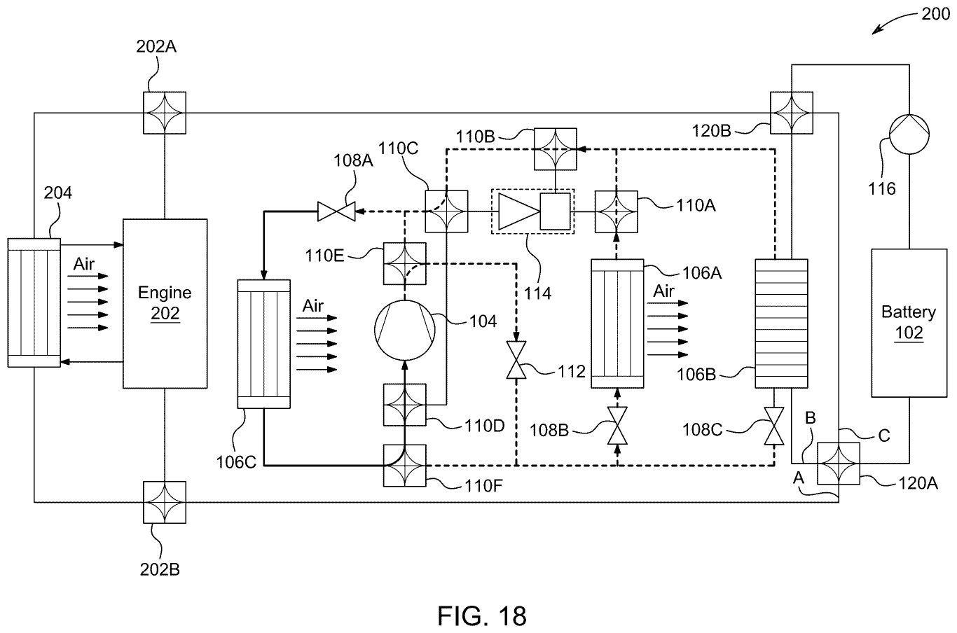

In some embodiments, as shown in FIG. 18, when only the passenger cabin of the HEV needs heating and the battery 102 does not require heating, the second condenser 106B may be isolated from the BTMS 200, and the entire refrigerant is directed to the first condenser 106A. In such a case, the controller 130 actuates the third throttling valve 108C to close such that flow of the refrigerant to the second condenser 106B is prevented and the entire refrigerant is allowed to flow through the first condenser 106A. Further, the refrigerant coming from the first condenser 106A is allowed to flow into the second evaporator 106C through the primary DCV 110A, the secondary DCV 110B and the ejector DCV 110C, such that the first condenser 106A helps to heat the passenger cabin.

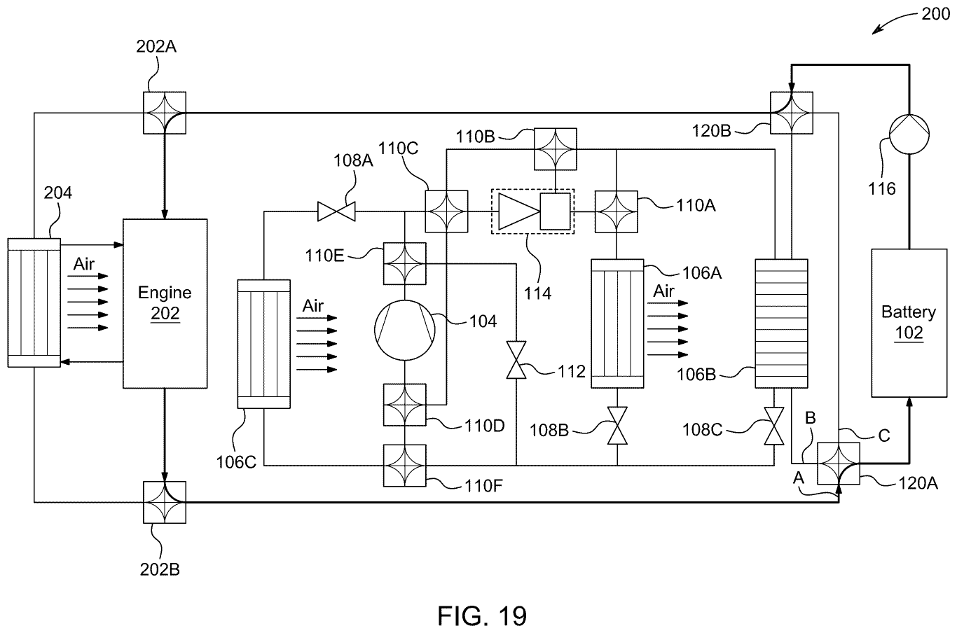

In some embodiments, as shown in FIG. 19, the engine 202 may be utilized to heat the battery 102 without engaging the refrigerant circuit by directing the coolant through the first coolant path ‘A’. In an embodiment, the controller 130 controls the battery input DCV 120A, the battery output DCV 120B, the engine input DCV 202A, and the engine output DCV 202B to direct the flow of coolant through the engine 202 in the first coolant path ‘A’ such that the operating temperature of the battery 102 is maintained within the optimal battery temperature range. Simultaneously, radiator may cool the engine 202 by exchanging heat with the colder environment.

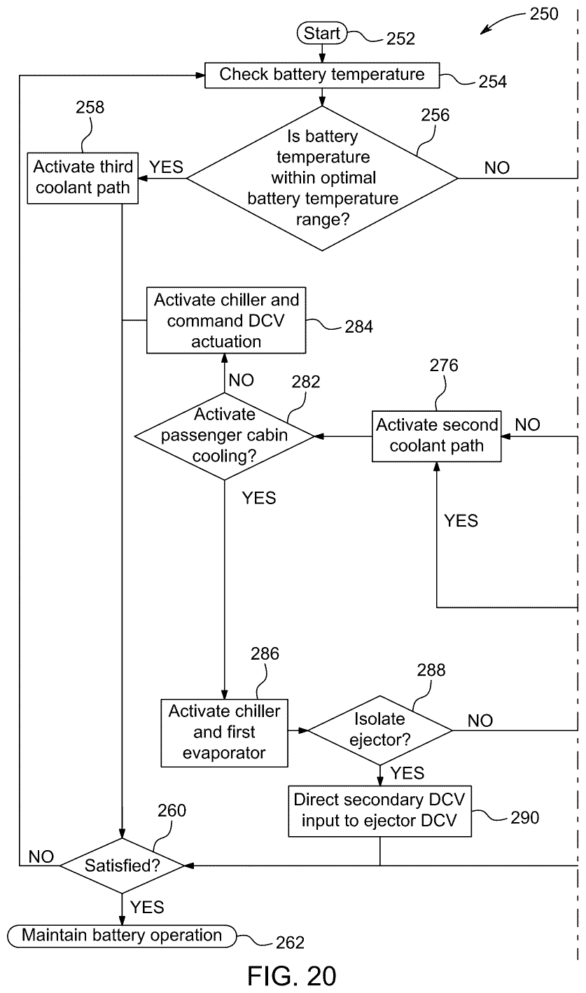

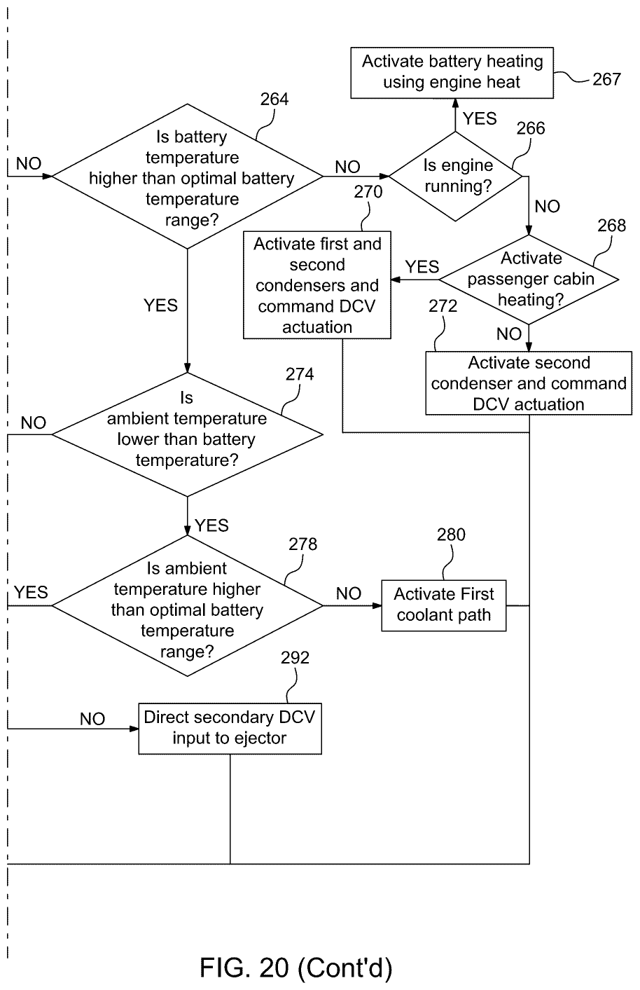

Referring to FIG. 20, a schematic flow diagram of a method 250 of operating the BTMS 200 implemented in the HEV is illustrated, according to an embodiment of the present disclosure. The operation of the BTMS 200 in both the cooling mode and the heating mode is explained in detail. At step 252, the HEV is started, so the BTMS 200 to operate the battery 102 at the desired operating temperature. At steps 254, 256, 258, 260 and 262, the controller 130 performs operations identical to the steps 154, 156, 158, 160 and 162 described in FIG. 11, respectively. At step 264, the controller 130 is configured to check if the operating temperature of the battery 102 is higher than the optimal battery temperature range when the detected operating temperature of the battery 102 is not within the optimal battery temperature range. At step 266, the controller 130 disposed in communication with the engine 202 is configured to check if the engine 202 is running. At step 267, the controller 130 controls the engine input DCV 202A and the engine output DCV 202B to allow the coolant to flow through the engine 202 for heating the coolant when the controller 130 determines that the engine 202 is running. At step 268, the controller 130 is configured to check if the passenger cabin needs heating when the controller 130 determines that the engine 202 is not running. For the sake of brevity, the steps 270, 272, 274, 276, 278, 280, 282, 284, 286, 288, 290, and 292 are not described in detail as the operation of the controller 130 at these steps are identical to the steps 170, 172, 174, 176, 178, 180, 182, 184, 186, 188, 190, and 192, respectively, described in FIG. 11.

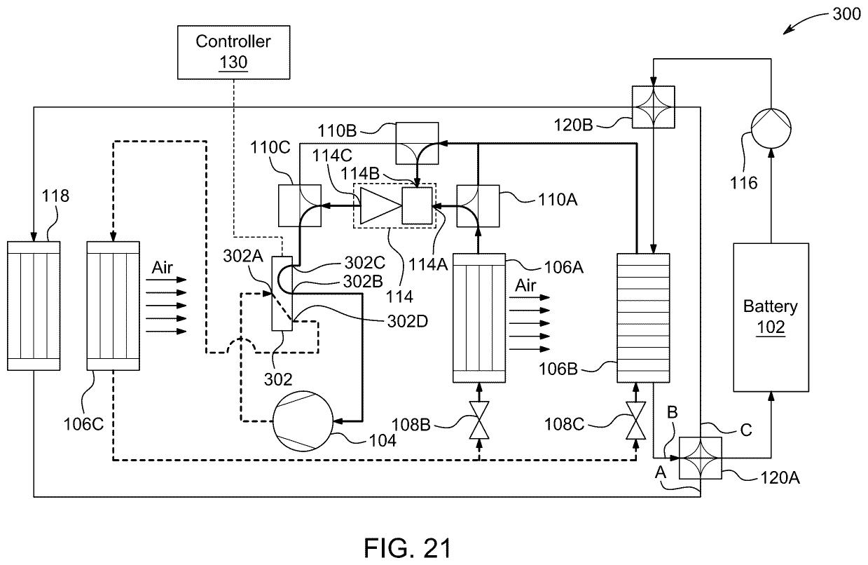

Referring to FIG. 21, a schematic block diagram of a BTMS 300 for the EV is illustrated, according to an embodiment of the present disclosure. The BTMS 300 is configured to control the operating temperature of the battery 102 of the EV during a heating mode or a cooling mode thereof. The EV includes the compressor 104, the plurality of heat exchangers, and the plurality of throttling valves for heating or cooling the battery 102 and the passenger cabin of the EV. The plurality of heat exchangers includes the first heat exchanger 106A, the second heat exchanger 106B, and the third heat exchanger 106C. The BTMS 300 includes a refrigerant circuit and a coolant circuit. The refrigerant circuit includes the vapor compression refrigeration system having the first heat exchanger 106A, the second heat exchanger 106B, the third heat exchanger 106C, the compressor 104, the plurality of throttling valves, the first set of DCVs, and a reversing valve 302.

In some embodiments, the reversing valve 302 may be an electro-mechanical 4-way valve that reverses a flow direction of the refrigerant using a solenoid which helps a sliding block to move back and forth as needed to switch between the heating mode and the cooling mode. In an embodiment, the controller 130 may be communicated with the reversing valve 302 to switch the operating mode of the BTMS 300 between the heating and cooling modes. In an embodiment, the reversing valve 302 includes a first opening 302A on one side and three openings such as a second opening 302B, a third opening 302C, and a fourth opening 302D on other side opposite the first opening 302A. The outlet of the compressor 104 is connected to the first opening 302A and the inlet of the compressor 104 is connected to the second opening 302B. The third opening 302C is connected to the first and second heat exchangers 106A, 106B via the second set of DCVs and the fourth opening 302D is connected to third heat exchanger 106C. The first opening 302A communicates the refrigerant with either the third opening 302C or the fourth opening 302D by various actuation methods including, but not limited to, an electrical actuation of the sliding block. The sliding block further connects either the third opening 302C or the fourth opening 302D with the second opening 302B. Compared to the configuration of the refrigerant circuit explained in FIG. 1 with reference to the BTMS 100, the reversing valve 302 is implemented in the BTMS 300 to replace the on/off valve 112, the compressor input DCV 110D, the compressor output DCV 110E, the reference DCV 110F and the first throttling valve 108A, which in turn improves reliability of the BTMS 300 and reduces cost and complexity in implementing the BTMS 300 in the EV.

During an operation of the BTMS 300, the first set of DCVs and the reversing valve 302 may be controlled by the controller 130 to direct a flow of the refrigerant though the refrigerant circuit to cool or heat the passenger cabin of the EV and the battery 102 as per the desired operating condition of the EV. The refrigerant circuit further includes the ejector 114 having the primary inlet 114A configured to communicate with the first heat exchanger 106A, the secondary inlet 114B configured to communicate with the first and second heat exchangers 106A, 106B, and the output 114C configured to communicate with the third heat exchanger 106C and the compressor 104 based on the desired operating condition of the EV and the operating modes of the BTMS 300. The first set of DCVs includes the primary DCV 110A configured to couple with the first heat exchanger 106A, the secondary DCV 110B configured to couple with the primary DCV 110A and the second heat exchanger 106B, and the ejector DCV 110C configured to couple with the output 114C of the ejector 114. Each of the first set of DCVs in the vapor compression refrigeration system includes three gates. The plurality of throttling valves includes the second throttling valve 108B and the third throttling valve 108C configured to couple with inputs of the first heat exchanger 106A and the second heat exchanger 106B, respectively. The revering valve 302 along with the second and third throttling valves 108B, 108C helps to accommodate a reversing flow of the refrigerant in the BTMS 300. The coolant circuit includes the battery 102, the pump 116, the battery cooler 118, and the second set of DCVs. During the operation of the BTMS 300, the second set of DCVs may be controlled to direct the flow of the coolant through the coolant circuit to cool or heat the battery 102 as per the desired operating condition of the EV. The second set of DCVs includes the battery output DCV 120B configured to couple the output of the battery 102 with the battery cooler 118 and the second heat exchanger 106B, and the battery input DCV 120A configured to couple the input of the battery 102 with the battery cooler 118 and the second heat exchanger 106B. Further, the battery input DCV 120A and the battery output DCV 120B are coupled to each other.

The BTMS 300 further includes the controller 130 configured to monitor and control the heating mode and the cooling mode operations of the BTMS 300 for optimal performance of the battery 102. In an embodiment, the controller 130 is configured to control the primary DCV 110A, the secondary DCV 110B, the ejector DCV 110C, the reversing valve 302, the battery input DCV 120A and the battery output DCV 120B based on the optimal battery temperature range of the battery 102, the coolant temperature of the battery 102, the ambient temperature of the EV, the passenger cabin temperature of the passenger cabin, and/or the optimal passenger cabin temperature range of the passenger cabin.

As shown in FIG. 21, the cooling mode operation of the BTMS 300 is illustrated in detail. For the illustration purpose of the cooling mode of the BTMS 300, the first heat exchanger 106A is referred to as the first evaporator 106A, the second heat exchanger 106B is referred to as the chiller 106B, and the third heat exchanger 106C is referred to as the third condenser 106C. The refrigerant circuit includes the vapor compression refrigeration system having the ejector 114 to reduce power consumption of the compressor 104 by increasing pressure of the refrigerant at the inlet of the compressor 104. The primary DCV 110A is configured to couple the first evaporator 106A to the primary inlet 114A of the ejector 114, the secondary DCV 110B is configured to couple the primary DCV 110A and the chiller 106B to the secondary inlet 114B of the ejector 114, and the ejector DCV 110C is configured to couple the output of the ejector 114 to the reversing valve 302. The reversing valve 302 is configured to couple the ejector DCV 110C through the compressor 104 to the third condenser 106C. A temperature-entropy diagram associated with the cooling mode of the BTMS 300 is identical to the temperature-entropy diagram of FIG. 2.

In the cooling mode, the compressor 104 receives the refrigerant from the ejector 114 and exits high pressure and high temperature refrigerant. In an embodiment, the third opening 302C of the reversing valve 302 is communicated with the ejector DCV 110C and communicates the low pressure and low temperature refrigerant with the second opening 302B which in turn communicates the refrigerant with the inlet of the compressor 104. Further, the first opening 302A that is in communication with the outlet of the compressor 104 communicates the high pressure and high temperature refrigerant with the fourth opening 302D such that the compressed air enters the third condenser 106C. The refrigerant circuit of the BTMS 300 does not require the first throttling valve 108A described in FIG. 1 and such omission of the first throttling valve 108A does not alter operational performance and control strategies of the BTMS 300. The refrigerant is further cooled in the third condenser 106C sensibly to become saturated vapor and condensation occurs to become a saturated liquid. After the third condenser 106C, the refrigerant is divided into an evaporator stream through the second throttling valve 108B and a chiller stream through the third throttling valve 108C. The refrigerant coming from the first evaporator 106A and the chiller 106B is fed into the ejector 114 which in turn communicates the refrigerant with the compressor 104 via the ejector DCV 110C and the reversing valve 302, and the cycle repeats.

The coolant loop of the BTMS 300 is in direct contact with the battery 102 of the EV to maintain the operating temperature thereof within the optimal battery temperature range. In the cooling mode, the coolant circuit includes the battery output DCV 120B configured to couple the battery 102 to the chiller 106B or to the battery input DCV 120A and the battery input DCV 120A configured to couple the battery output DCV 120B or the chiller 106B to the battery 102. In some embodiments, when the coolant temperature is higher than the optimal battery temperature range and the ambient temperature is lower than the optimal battery temperature range, the controller 130 activates the first coolant path ‘A’ to allow the coolant to flow therethrough. In an embodiment, the controller 130 controls the battery output DCV 120B to couple the battery 102 to the battery cooler 118 and controls the battery input DCV 120A to couple the battery cooler 118 to the battery 102. In some embodiments, when the coolant temperature is higher than the optimal battery temperature range and the ambient temperature is higher than the coolant temperature, the controller 130 activates the second coolant path ‘B’ to allow the coolant to flow through the chiller 106B. In an embodiment, the controller 130 controls the battery output DCV 120B to couple the battery 102 to the chiller 106B and controls the battery input DCV 120A to couple the chiller 106B to the battery 102 such that the refrigerant flowing through the chiller 106B removes heat from the coolant to maintain the operating temperature of the battery 102 within the optimal battery temperature range. In some embodiments, when the coolant temperature is within the optimal battery temperature range, the controller 130 activates the third coolant path ‘C’ to allow the coolant to flow therethrough. In an embodiment, the controller 130 controls the battery output DCV 120B to couple the battery 102 to the battery input DCV 120A and controls the battery input DCV 120A to couple the battery output DCV 120B to the battery 102.

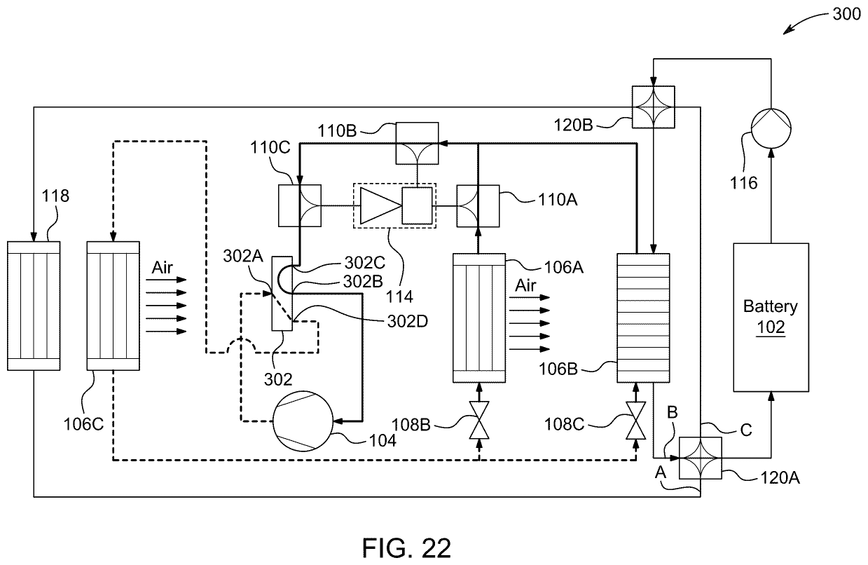

In some embodiments, as shown in FIG. 22, the primary DCV 110A, the secondary DCV 110B and the ejector DCV 110C may be controlled by the controller 130 to isolate the ejector 114 from the refrigerant circuit. In such a case, the primary DCV 110A and the secondary DCV 110B may be controlled to prevent flow of the refrigerant into the ejector 114 and the refrigerant coming from the first evaporator 106A is mixed with the refrigerant coming from the chiller 106B before entering the secondary DCV 110B. In an embodiment, the primary DCV 110A is configured to couple the first evaporator 106A to the secondary DCV 110B, the secondary DCV 110B is configured to couple the primary DCV 110A and the chiller 106B to the ejector DCV 110C, and the ejector DCV 110C is configured to couple the secondary DCV 110B to the reversing valve 302. The mixed stream of the evaporator stream and the chiller stream is allowed to communicate with the compressor 104 though the ejector DCV 110C.

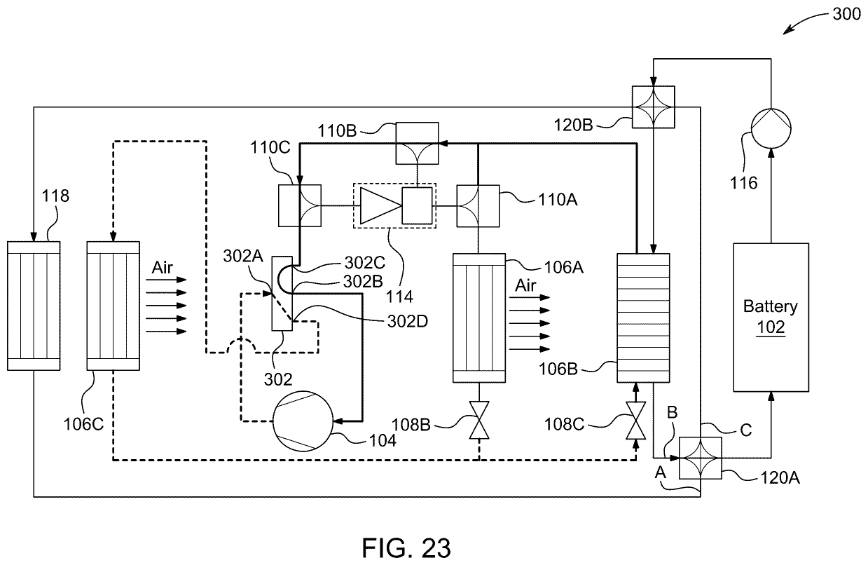

In some embodiments, as shown in FIG. 23, when only the battery 102 needs cooling and the passenger cabin does not require cooling, the first evaporator 106A and the ejector 114 are isolated from the BTMS 300, and the entire refrigerant is directed to the chiller 106B. In such a case, the controller 130 actuates the second throttling valve 108B to close such that flow of the refrigerant to the first evaporator 106A is prevented and the entire refrigerant is allowed to flow through the chiller 106B. Further, the refrigerant coming from the chiller 106B is allowed to flow into the compressor 104 through the secondary DCV 110B, the ejector DCV 110C, and the reversing valve 302. Therefore, the chiller 106B may remove the heat from the coolant flowing therethrough to cool the coolant temperature and thereby reduce the operating temperature of the battery 102. In some embodiments, when the coolant temperature is higher than the optimal battery temperature range and the passenger cabin temperature is within the optimal passenger cabin temperature range, the controller 130 controls the second throttling valve 108B coupled between the first evaporator 106A and the third condenser 106C to be closed. Further, the controller 130 controls the primary DCV 110A to couple the first evaporator 106A to the secondary DCV 110B, and controls the secondary DCV 110B to couple the primary DCV 110A and the chiller 106B to the ejector DCV 110C to remove heat from the coolant flowing through the second coolant path ‘B’.

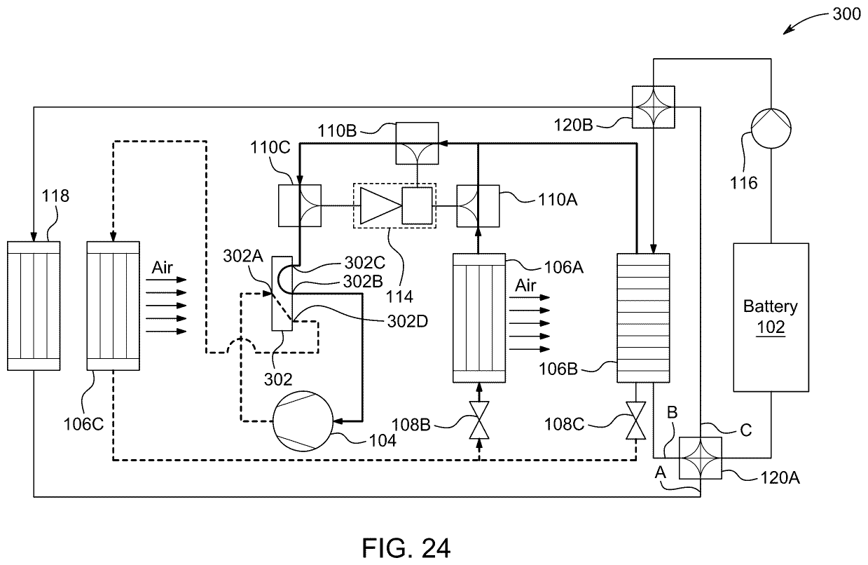

In some embodiments, as shown in FIG. 24, when only the passenger cabin needs cooling and the battery 102 does not require cooling, the chiller 106B and the ejector 114 are isolated from the BTMS 300, and the entire refrigerant is directed to the first evaporator 106A. In such a case, the controller 130 actuates the third throttling valve 108C to close such that flow of the refrigerant to the chiller 106B is prevented and the entire refrigerant is allowed to flow through the first evaporator 106A. Further, the refrigerant coming from the first evaporator 106A is allowed to flow into the compressor 104 through the primary DCV 110A, the secondary DCV 110B, the ejector DCV 110C and the reversing valve 302, such that the first evaporator 106A helps to cool the passenger cabin of the EV.

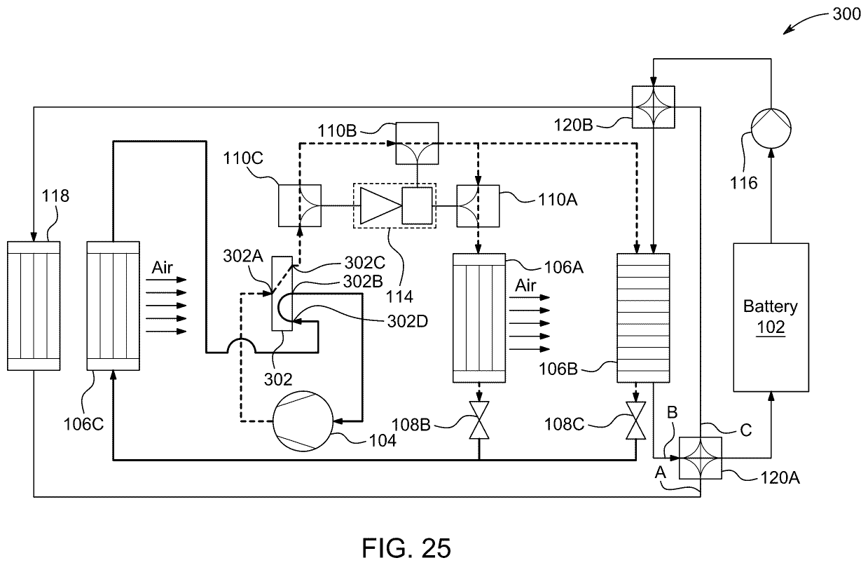

Referring to FIG. 25, a schematic block diagram of the BTMS 300 operating in the heating mode is illustrated, according to an embodiment of the present disclosure. For the illustration purpose of the heating mode of the BTMS 300, the first heat exchanger 106A is referred to as the first condenser 106A, the second heat exchanger 106B is referred to as the second condenser 106B, and the third heat exchanger 106C is referred to as the second evaporator 106C. In the heating mode, the primary DCV 110A is configured to couple the first condenser 106A to the secondary DCV 110B, the secondary DCV 110B is configured to couple the primary DCV 110A and the second condenser 106B to the ejector DCV 110C, and the ejector DCV 110C is configured to couple the reversing valve 302 to the secondary DCV 110B. The reversing valve 302 is configured to couple the second evaporator 106C through the compressor 104 to the ejector DCV 10C. In the heating mode, the compressor 104 receives the refrigerant from the second evaporator 106C and exits high pressure and high temperature refrigerant. In an embodiment, the fourth opening 302D of the reversing valve 302 is coupled to the second evaporator 106C and communicates the low pressure and low temperature refrigerant with the second opening 302B which in turn communicates the refrigerant with the inlet of the compressor 104. Further, the first opening 302A that is in communication with the outlet of the compressor 104 communicates the high pressure and high temperature refrigerant with the third opening 302C such that the compressed air enters the first condenser 106A and the second condenser 106B. After passing through the compressor 104, the refrigerant is divided into a first condenser stream and a second condenser stream and enters the first condenser 106A and the second condenser 106B, respectively. The refrigerant is further cooled in the first and second condensers 106A, 106B sensibly to become saturated vapor and condensation occurs to become a saturated liquid. After passing through the first condenser 106A and the second condenser 106B, respectively, the first condenser stream and the second condenser stream are allowed to enter the second evaporator via the second throttling valve 108B and the third throttling valve 108C, respectively. The second and third throttling valves 108B, 108C are activated by the controller 130 to reduce the saturated high temperature and high pressure of the refrigerant to a low temperature and low pressure two-phase refrigerant compatible with a desired operating condition of the second evaporator 106C. The refrigerant enters the second evaporator 106C and further enters the compressor 104 via the reversing valve 302, and the cycle repeats.

The coolant loop of the BTMS 300 is in direct contact with the battery 102 of the EV to maintain the operating temperature thereof within the optimal battery temperature range. In the heating mode, the coolant circuit includes the battery output DCV 120B configured to couple the battery 102 to the second condenser 106B or to the battery input DCV 120A and the battery input DCV 120A configured to couple the battery output DCV 120B or the second condenser 106B to the battery 102. When the coolant temperature of the battery 102 is less than the optimal battery temperature range and the ambient temperature is also less, then the BTMS 300 may be operated in the heating mode to increase the coolant temperature to the optimal battery temperature range. In some embodiments, when the coolant temperature is lower than the optimal battery temperature range and the ambient temperature is lower than the coolant temperature, the controller 130 activates the second coolant path ‘B’ to allow the coolant to flow through the second condenser 106B. In an embodiment, the controller 130 controls the battery output DCV 120B to couple the battery 102 to the second condenser 106B and controls the battery input DCV 120A to couple the second condenser 106B to the battery 102 such that the heat is added to the coolant from the high temperature and high pressure refrigerant.

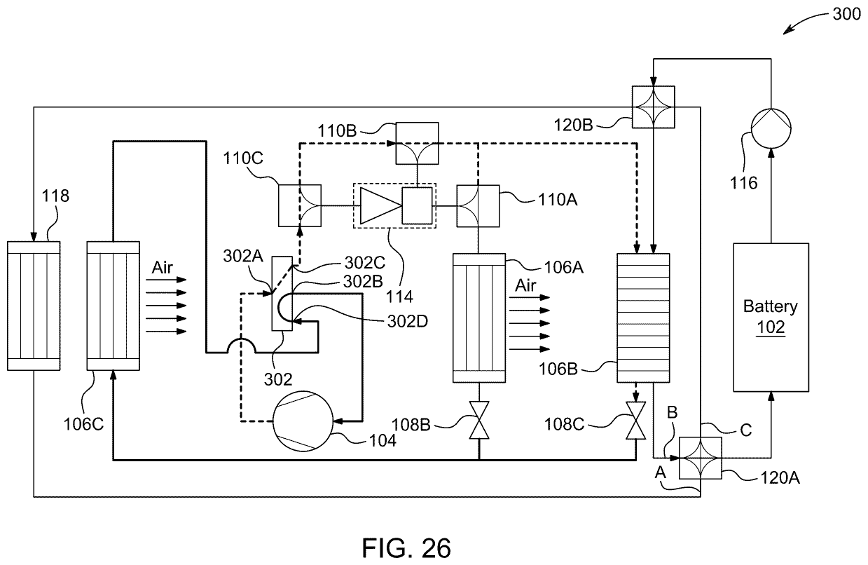

In some embodiments, as shown in FIG. 26, when only the battery 102 needs heating and the passenger cabin does not require heating, the first condenser 106A is isolated from the BTMS 300, and the entire refrigerant is directed to the second condenser 106B. In such a case, the controller 130 actuates the second throttling valve 108B to close such that flow of the refrigerant to the first condenser 106A may be prevented and the entire refrigerant is allowed to flow through the second condenser 106B. Further, the refrigerant coming from the second condenser 106B is allowed to flow into the second evaporator 106C such that the second condenser 106B may heat the coolant flowing therethrough and thereby increase the operating temperature of the battery 102. In some embodiments, when the coolant temperature is lower than the optimal battery temperature range and the passenger cabin temperature is within the optimal passenger cabin temperature range, the controller 130 controls the second throttling valve 108B disposed between the first condenser 106A and the second evaporator 106C to be closed. The controller 130 further controls the primary DCV 110A to couple the first condenser 106A to the secondary DCV 110B, and controls the secondary DCV 110B to couple the primary DCV 110A and the second condenser 106B to the ejector DCV 110C to add heat to the coolant flowing through the second coolant path ‘B’.

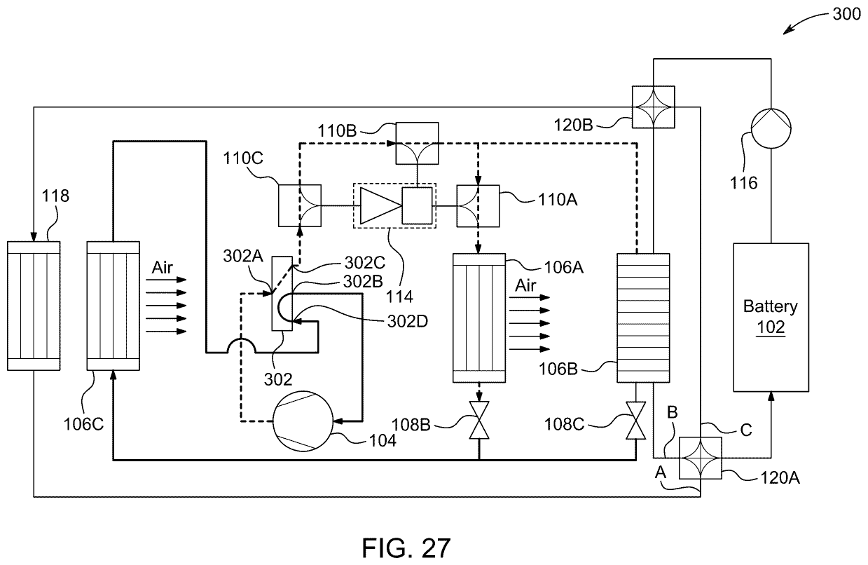

In some embodiments, as shown in FIG. 27, when only the passenger cabin needs heating and the battery 102 does not require heating, the second condenser 106B is isolated from the BTMS 300, and the entire refrigerant is directed to the first condenser 106A. In such a case, the controller 130 actuates the third throttling valve 108C to close such that flow of the refrigerant to the second condenser 106B is prevented and the entire refrigerant is allowed to flow through the first condenser 106A. Further, the refrigerant coming from the first condenser 106A is allowed to flow into the second evaporator 106C such that the first condenser 106A helps to heat the passenger cabin.

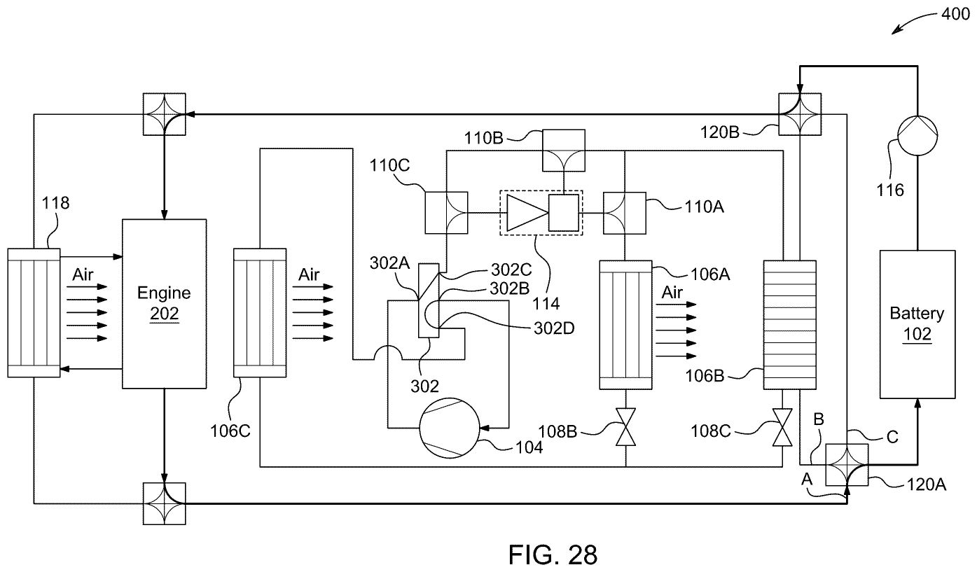

In some embodiments, as shown in FIG. 28, a BTMS 400 may be implemented in the HEV. In such a case, the controller 130 is configured to control the primary DCV 110A, the secondary DCV 110B, the ejector DCV 110C, the reversing valve 302, the battery input DCV 120A and the battery output DCV 120B based on the operation of the engine 202 of the HEV. As shown in FIG. 28, the engine 202 may be utilized to heat the battery 102 without engaging the refrigerant circuit of the BTMS 400 by directing the coolant through the first coolant path ‘A’. In an embodiment, the controller 130 controls the battery input DCV 120A, the battery output DCV 120B, the engine input DCV 202A, and the engine output DCV 202B to direct the flow of coolant through the engine 202 in the first coolant path ‘A’ such that the operating temperature of the battery 102 is maintained within the optimal battery temperature range. Simultaneously, the radiator may cool the engine 202 by exchanging heat with the colder environment. Various operating scenarios of the BTMS 300 described with reference to FIG. 21 to FIG. 27 may be implemented in the HEV.

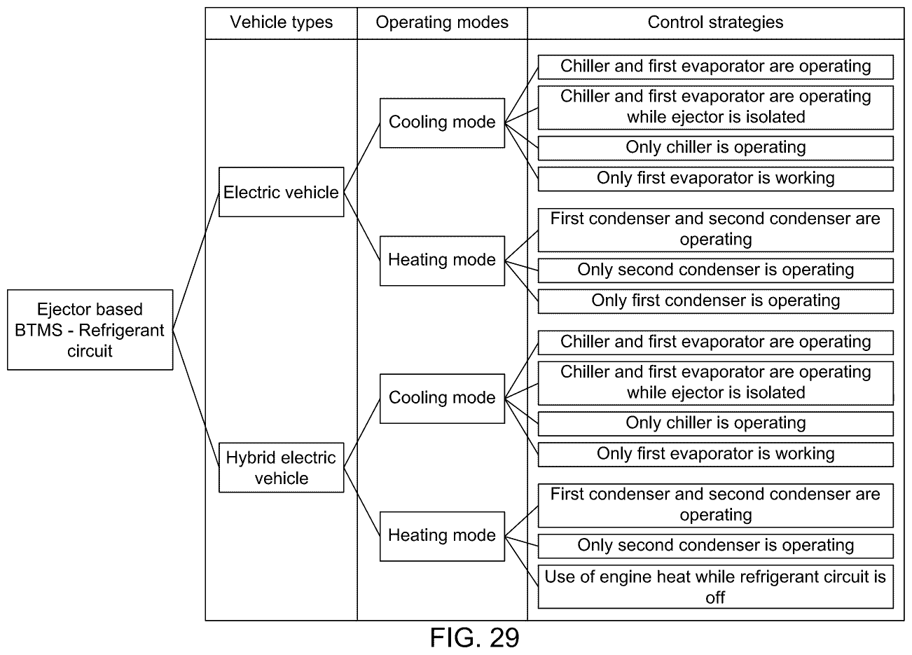

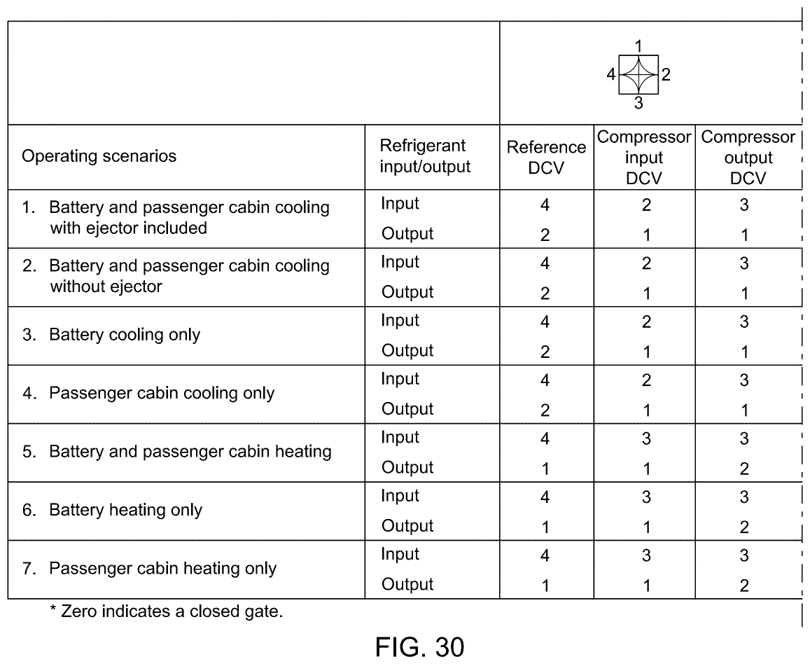

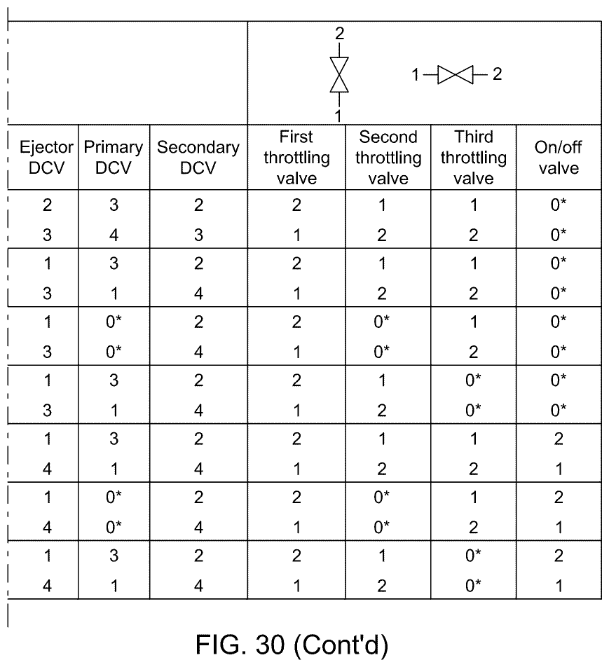

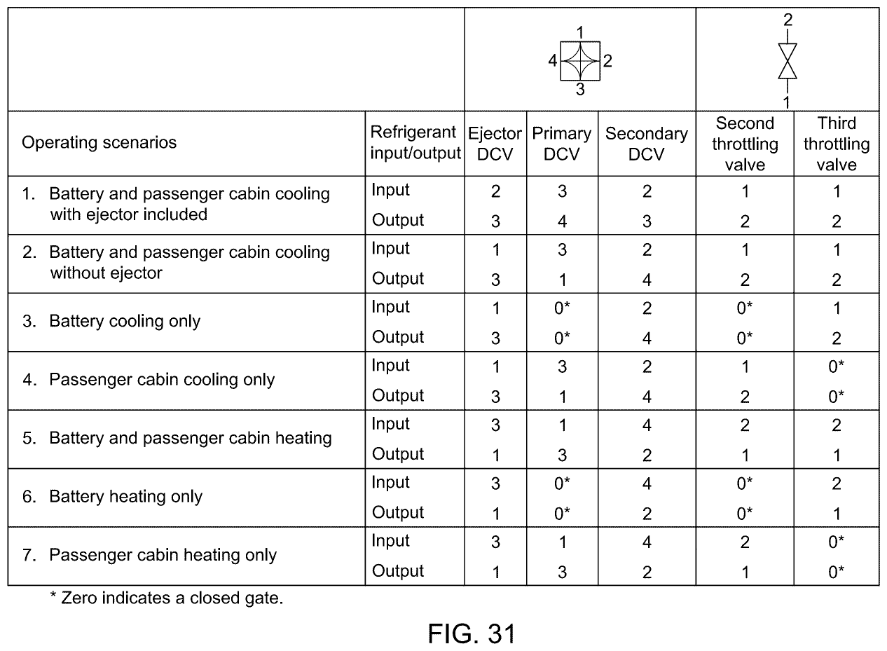

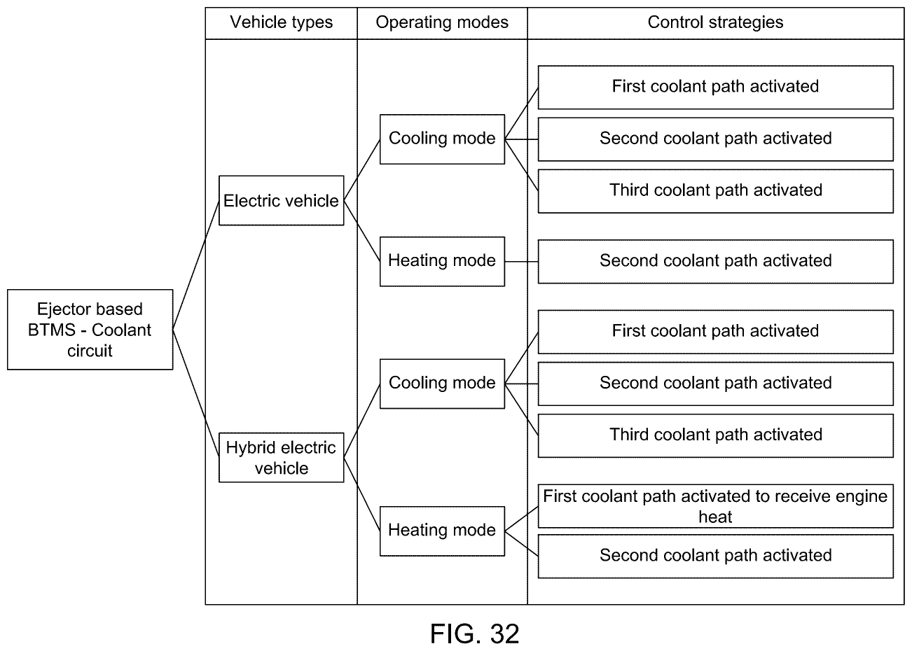

According to the present disclosure, the BTMS having the coolant circuit and the refrigerant circuit based on dual-evaporator vapor compression system equipped with the ejector 114 is developed to enhance energy performance thereof and improve operational efficiency of the EV and the HEV. In an embodiment, the BTMS is operated to heat or cool the battery 102 by redirecting the refrigerant in the refrigerant circuit using the plurality of DCVs in the EV and using the plurality of DCVs, and the engine input and output DCVs 202A, 202B in the HEV. A summary of the operating modes and the control strategies of the refrigerant circuit of the BTMS discussed in detail with reference to FIG. 1 to FIG. 28 is illustrated in FIG. 29. A summary of selection of gates of the primary DCV 110A, the secondary DCV 110B, the ejector DCV 110C, the compressor input DCV 110D, the compressor output DCV 110E, the reference DCV 110F, the first throttling valve 108A, the second throttling valve 108B, the third throttling valve 108C, and the on/off valve 112 of the BTMS described with respect to the various operating modes and the control strategies in FIG. 1, FIG. 4 to FIG. 7, FIG. 9 to FIG. 10, FIG. 12 to FIG. 19 is illustrated in FIG. 30. In the refrigerant circuit, a DCV with three gates may be implemented except for the ejector DCV 110 which requires 4 gates. Referring to FIG. 21 to FIG. 27, after selecting one of the operating modes and the control strategies in the refrigerant circuit, the primary DCV 110A, the secondary DCV 110B, the ejector DCV 110C, the second throttling valve 108B, and the third throttling valve 108C are actuated by the controller 130 as illustrated in FIG. 31. Each gate of the DCV and throttling valve input and output ports are designated with numbers as shown in FIG. 31. Although the DCVs in the BTMS 300 have only three gates, the DCVs are shown with four gates to avoid numbering confusion with different orientations of the DCVs. A summary of the operating modes and the control strategies of the coolant circuit of the BTMS discussed in detail with reference to FIG. 1 to FIG. 28 is illustrated in FIG. 32.

The BTMS of the present disclosure leverages different evaporator pressures to boost the inlet compressor pressure by incorporating the ejector 114 which helps to improve performance of the BTMS without increasing system complexity. Depending on operating conditions of the EV and the HEV, the BTMS may heat or cool the battery 102. Further, the ejector 114 is a simple component with no moving parts, which leads to simple installation, testing, and operation of the BTMS. The BTMS of the present disclosure replaces current method of linking the evaporators directly to the compressor 104 at lower capital and operational expenditure costs, due to a smaller capacity compressor and condenser needed for carrying out the heat pumping process.

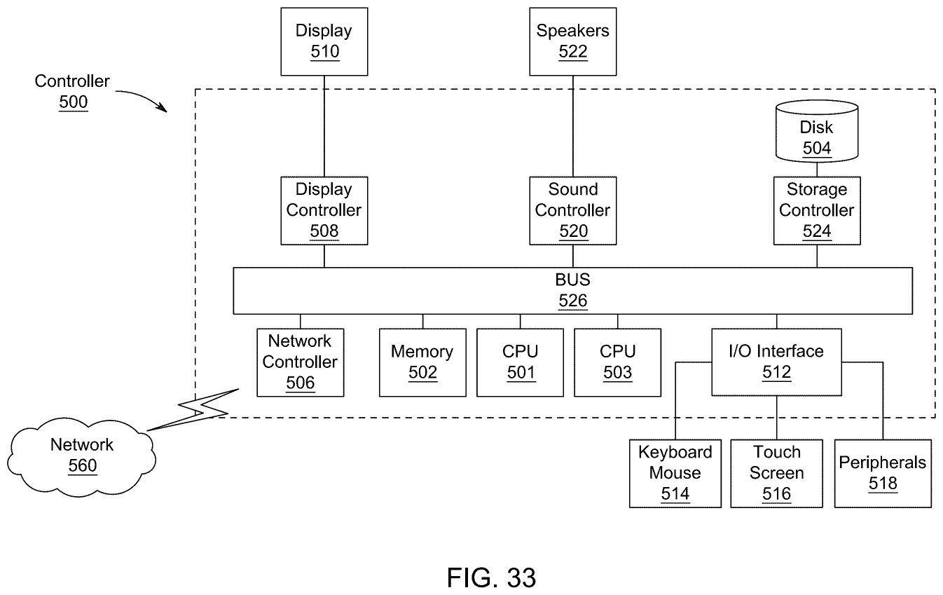

Details of hardware description of computing environment according to exemplary embodiments is described with reference to FIG. 33. In FIG. 33, a controller 500 is described which is representative of the controller 130 of FIG. 1 which includes a CPU 501 which performs the processes described above/below. The process data and instructions may be stored in memory 502. These processes and instructions may also be stored on a storage medium disk 504 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 501, 503 and an operating system such as Microsoft Windows 7, Microsoft Windows 10, Microsoft Windows 11, UNIX, Solaris, LINUX, Apple MAC-OS and other systems known to those skilled in the art.

The hardware elements in order to develop the controller 500 may be realized by various circuitry elements, known to those skilled in the art. For example, CPU 501 or CPU 503 may be a Xenon or Core processor from Intel of America or an Opteron processor from AMD of America, or may be other processor types that would be recognized by one of ordinary skill in the art. Alternatively, the CPU 501, 503 may be implemented on an FPGA, ASIC, PLD or using discrete logic circuits, as one of ordinary skill in the art would recognize. Further, CPU 501, 503 may be implemented as multiple processors cooperatively working in parallel to perform the instructions of the inventive processes described above.

The controller 500 may also include a network controller 506, such as an Intel Ethernet PRO network interface card from Intel Corporation of America, for interfacing with network 560. As can be appreciated, the network 560 can be a public network, such as the Internet, or a private network such as an LAN or WAN network, or any combination thereof and can also include PSTN or ISDN sub-networks. The network 560 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The controller 500 may further include a display controller 508, such as a NVIDIA Geforce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface also connects to a variety of peripherals 518 including printers and scanners, such as an OfficeJet or DeskJet from Hewlett Packard.

A sound controller 520 is also provided in the controller 500 such as Sound Blaster X-Fi Titanium from Creative, to interface with speakers/microphone 522 thereby providing sounds and/or music.

The storage controller 524 connects the storage medium disk 504 with communication bus 526, which may be an ISA, EISA, VESA, PCI, or similar, for interconnecting all of the components of the controller 500. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

### Performance Analysis and Comparison

According to the present disclosure, the BTMS is implemented in the EV and the HEV to reduce the coolant temperature of the battery 102. Performance of the BTMS is compared based on two methods of implementing the BTMS. A first method of implementation, otherwise referred to as ‘the ejector-based system’, includes the first evaporator 106A and the chiller 106B operating together with the ejector 114 as described in FIG. 1. A second method of implementation, otherwise referred to as ‘the reference system’, includes the first evaporator 106A and the chiller 106B operating together while the ejector 114 is isolated as described in FIG. 4. Incorporation of the ejector 114 is done by controlling the first set of directional control valves using the controller 130.

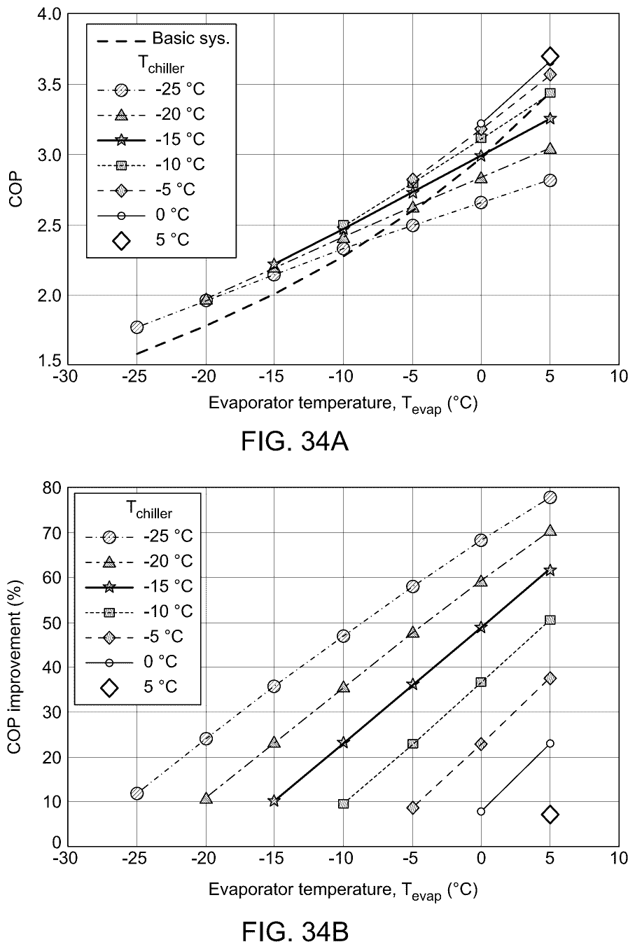

The influence of temperature values of the first evaporator 106A and the chiller 106B on coefficient of performance (COP) of the ejector-based system compared to the reference system is shown in FIG. 34A. FIG. 34B shows the COP improvement compared to the reference system. For a fair comparison between the ejector-based system and the reference system, the lowest saturated temperature (i.e., T_{chiller}) and the highest saturated temperature (i.e., condenser temperature (T_{cond})) in both the systems should be maintained. That is, the working temperature limits of both the systems must be maintained. Therefore, each T_{chiller} line of the ejector-based system should be compared to the point in the reference system representing T_{chiller}=Tₑᵥₐₚ. For instance, the line representing T_{chiller}=−25° C. should be compared to the point where Tₑᵥₐₚ=T_{chiller}=−25° C. in the reference system.

As shown in FIG. 34A, the COP improves significantly for all the investigated evaporator and chiller temperature values. At T_{chiller}=Tₑᵥₐₚ=−25° C., the COP of the ejector-based system improves by 11.9% compared to the reference system. This indicates that the ejector-based system immediately improves the performance even at the same chiller and evaporator temperature. Generally, the ejector 114 improves COP by about 7.17%-11.9% when the chiller 106B and the first evaporator 106A are working at the same temperature. However, when the working temperature is different for the chiller 106B and the first evaporator 106A, further improvements are realized, reaching up to 77.9% for T_{chiller}=−25° C. and Tₑᵥₐₚ=5° C. Altogether, the improvement in the COP of the ejector-based system is between 7.17% and 77.9%, as shown in FIG. 34B.

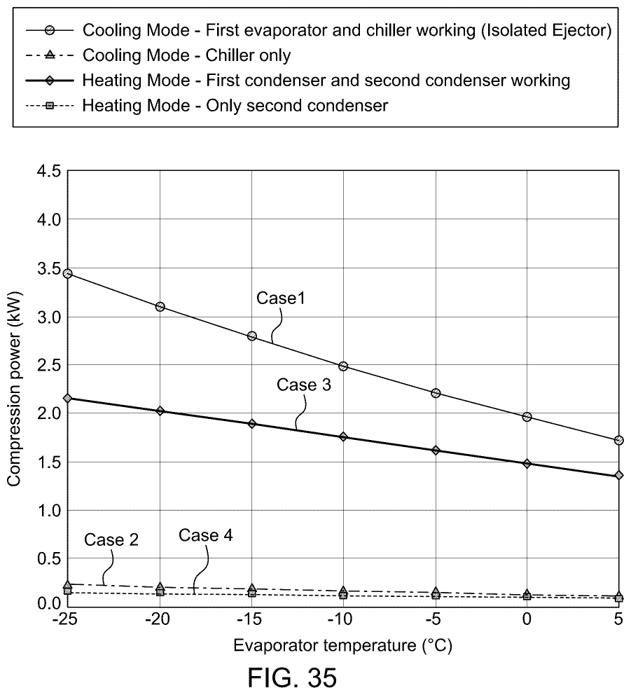

FIG. 35 shows the effect of evaporator temperature on the compressor power consumption for different operating scenarios. The chiller and condenser temperatures are −25° C. and 50° C., respectively. It was assumed during the analysis that the thermal load on the chiller 106B and the first evaporator 106A (or the first and second condensers 106A, 106B) will be unchanged. This is because, regardless of heating or cooling modes of the battery 102 and/or the passenger cabin, the thermal loads will be the same.

Therefore, it is evident that the case 1 has a higher compression power than case 3 because of the larger evaporator capacity for case 1. Similarly, case 2 and case 4 when only the chiller 106B and the second condenser 106B are active leads to the same conclusion as above. It is worth mentioning that for all four cases, the COP is identical for all, as shown in FIG. 34B for the reference case.

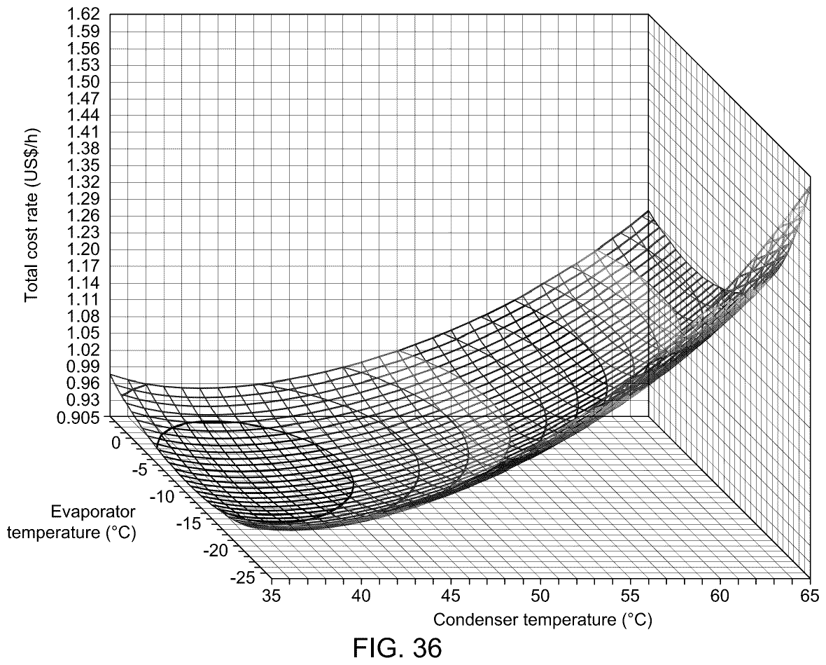

To visualize a global variation of total cost rate, FIG. 36 shows a three dimensional surface plot of the total cost rate of the BTMS as a function of condenser and evaporator temperature values for T_{chiller}=−25° C. For all condenser temperature values, a minimal value is present at a specific Tₑᵥₐₚ, and vice versa. A global minimal total cost rate of US $0.9092 per hour is found at Tₑᵥₐₚ=−8° C., T_{cond}=39° C., and T_{chiller}=−25° C., and total exergy destruction and second law efficiency values are 1.596 KW and 14.22%, respectively. The total cost rate increases substantially for higher condenser temperature values and lower evaporator temperature values.

Further, the model of the present disclosure indicates a global minimum value of the total cost rate for other chiller temperature values. The findings help optimize design of the BTMS to reduce the environmental footprint by optimally sizing, manufacturing, and operating the different components of the BTMS. As for the reference system, the minimal total cost rate, the total exergy destruction, and the second law efficiency were found to be US $1.0222 per hour, 2.243 kW, and 10.23%, respectively, at a Tₑᵥₐₚ=T_{chiller}=−25° C. and T_{cond}=39° C. The analysis showing significant technical and economic performance improvements are found in [Alkhulaifi Y M, Qasem N A A, Zubair S M. Improving the performance of thermal management system for electric and hybrid electric vehicles by adding an ejector. Energy Convers Manag 2019; 201:112133.] and [Alkhulaifi Y M, Qasem N A A, Zubair S M. Exergoeconomic Assessment of the Ejector-Based Battery Thermal Management System for Electric and Hybrid-Electric Vehicles. SSRN Electron J 2021.]

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Obviously, numerous modifications and variations of the present disclosure are possible in light of the above teachings. It is therefore to be understood that within the scope of the appended claims, the present disclosure may be practiced otherwise than as specifically described herein.

1-9. (canceled)

10. A battery thermal management system (BTMS) for an electric vehicle (EV) in cooling mode or heating mode, the EV including a battery, a first condenser for heating a passenger cabin of the EV, a second condenser for heating the battery, a third condenser, a compressor, a chiller for cooling the battery, a first evaporator for cooling the passenger cabin, and a second evaporator, the BTMS comprising an ejector, a primary directional control valve (DCV), a secondary DCV, an ejector DCV, a reversing valve, a battery output DCV, a battery input DCV and a controller, wherein:
the ejector has a primary inlet, a secondary inlet and an output,
the primary DCV is configured to couple the first evaporator to the primary inlet of the ejector or to the secondary DCV in the cooling mode, and to couple the secondary DCV to the first condenser in the heating mode,
the secondary DCV is configured to couple the primary DCV and the chiller to the secondary inlet of the ejector or to the ejector DCV in the cooling mode, and to couple the ejector DCV to the primary DCV and the second condenser in the heating mode,
the ejector DCV is configured to couple the output of the ejector or the secondary DCV to the reversing valve in the cooling mode, or to couple the reversing valve to secondary DCV in the heating mode,
the reversing valve is configured to couple the ejector DCV through the compressor to the third condenser in the cooling mode, or to couple the second evaporator through the compressor to the ejector DCV in the heating mode,
the battery output DCV is configured to couple the battery to the chiller or to the battery input DCV in the cooling mode, or to couple the battery to the second condenser or to the battery input DCV in the heating mode,
the battery input DCV is configured to couple the battery output DCV or the chiller to the battery in the cooling mode, or to couple the second condenser or the battery output DCV to the battery in the heating mode, and
the controller is configured to control the primary DCV, the secondary DCV, the ejector DCV, the reversing valve, the battery input DCV and the battery output DCV based on an optimal battery temperature range of the battery, a coolant temperature of the battery, an ambient temperature of the EV, a passenger cabin temperature of the passenger cabin, and/or an optimal passenger cabin temperature range of the passenger cabin.

11. The BTMS of claim 10, wherein the EV further includes a battery cooler, the battery output DCV is further configured to couple the battery to the battery cooler, and the battery input DCV is further configured to couple the battery cooler to the battery.

12. The BTMS of claim 11, wherein when the coolant temperature is higher than the optimal battery temperature range and the ambient temperature is lower than the optimal battery temperature range, the controller controls the battery output DCV to couple the battery to the battery cooler and controls the battery input DCV to couple the battery cooler to the battery.

13. The BTMS of claim 11, wherein when the coolant temperature is higher than the optimal battery temperature range and the ambient temperature is higher than the coolant temperature, the controller controls the battery output DCV to couple the battery to the chiller and controls the battery input DCV to couple the chiller to the battery.

14. The BTMS of claim 11, wherein when the coolant temperature is within the optimal battery temperature range, the controller controls the battery output DCV to couple the battery to the battery input DCV and controls the battery input DCV to couple the battery output DCV to the battery.

15. The BTMS of claim 11, further comprising a throttling valve coupled between the first evaporator and the third condenser, wherein when the coolant temperature is higher than the optimal battery temperature range and the passenger cabin temperature is within the optimal passenger cabin temperature range, the controller controls the throttling valve to be closed, controls the primary DCV to couple the first evaporator to the secondary DCV, and controls the secondary DCV to couple the primary DCV and the chiller to the ejector DCV.

16. The BTMS of claim 11, wherein when the coolant temperature is lower than the optimal battery temperature range and the ambient temperature is lower than the coolant temperature, the controller controls the battery output DCV to couple the battery to the second condenser and controls the battery input DCV to couple the second condenser to the battery.

17. The BTMS of claim 11, further comprising a throttling valve coupled between the first condenser and the second evaporator, wherein when the coolant temperature is lower than the optimal battery temperature range and the passenger cabin temperature is within the optimal passenger cabin temperature range, the controller controls the throttling valve to be closed, controls the primary DCV to couple the first condenser to the secondary DCV, and controls the secondary DCV to couple the primary DCV and the second condenser to the ejector DCV.

18. The BTMS of claim 10, wherein the EV is a hybrid electric vehicle (HEV), and the controller is configured to control the primary DCV, the secondary DCV, the ejector DCV, the reversing valve, the battery input DCV and the battery output DCV further based on an engine operation of the HEV.
